(19) United States
(12) Patent Application Publication
(10) Pub. No.: US 2025/0271637 A1
(43) Pub. Date: Aug. 28, 2025

(54) IMAGING LENS AND IMAGING APPARATUS

(71) Applicant: FUJIFILM Corporation, Tokyo (JP)

(72) Inventor: Ryoko TOMIOKA, Saitama (JP)

(73) Assignee: FUJIFILM Corporation, Tokyo (JP)

(21) Appl. No.: 19/048,423

(22) Filed: Feb. 7, 2025

(30) Foreign Application Priority Data
Feb. 28, 2024 (JP) 2024-029016

(51) Int. Cl. G02B 9/64

(52) U.S. Cl. CPC G02B 9/64

(57) ABSTRACT

An imaging lens consists of, in order from an object side to an image side, a first lens group having a positive refractive power, a second lens group having a negative refractive power, and a third lens group having a positive refractive power. During focusing, at least the second lens group moves. The second lens group is a group closest to the object side among groups that move during the focusing. The first lens group includes, in consecutive order from a position closest to the object side to the image side, two positive lenses. The third lens group includes a lens component having a negative refractive power closest to the image side. The imaging lens satisfies a predetermined conditional expression.

### CROSS-REFERENCE TO RELATED APPLICATIONS

This application claims priority from Japanese Patent Application No. 2024-029016, filed on Feb. 28, 2024, the entire disclosure of which is incorporated herein by reference.

### BACKGROUND

### Technical Field

The disclosed technology relates to an imaging lens and an imaging apparatus.

### Related Art

In the related art, lens systems according to 2019-023693A and JP2015-111254A have been known as an imaging lens used in a digital camera or the like.

### SUMMARY

There is a demand for an imaging lens that has a large image circle and a small F-number and that is configured to be further reduced in size and favorably corrected in terms of aberrations.

An object of the present disclosure is to provide an imaging lens that has a large image circle and a small F-number and that is configured to be further reduced in size and favorably corrected in terms of aberrations, and an imaging apparatus comprising the imaging lens.

According to an aspect of the disclosed technology, there is provided an imaging lens consisting of, in order from an object side to an image side, a first lens group having a positive refractive power, a second lens group having a negative refractive power, and a third lens group having a positive refractive power, in which, during focusing, at least the second lens group moves along an optical axis, the second lens group is a group closest to the object side among groups that move during the focusing, the first lens group includes, in consecutive order from a position closest to the object side to the image side, two positive lenses, in a case where one lens component is one single lens or one cemented lens, the third lens group includes a lens component having a negative refractive power closest to the image side, and Conditional Expressions (1) and (2) are satisfied, which are represented by

$$\begin{matrix}0.14 < DG 1 / DA < 0.5 and & ( 1 ) \\ 0.02 < ( tan ω m ) / Fno < 0.15 . & ( 2 )\end{matrix}$$

A distance on the optical axis from a lens surface of the first lens group closest to the object side to a lens surface of the first lens group closest to the image side is denoted by DG1. A distance on the optical axis from the lens surface of the first lens group closest to the object side to a lens surface of the third lens group closest to the image side in a state where an infinite distance object is in focus is denoted by DA. A maximum half angle of view in the state where the infinite distance object is in focus is denoted by ωm. An open F-number in the state where the infinite distance object is in focus is denoted by Fno.

In a case where an average value of Abbe numbers based on a d line for all positive lenses included in the first lens group is denoted by v1pave, the imaging lens of the aspect preferably satisfies Conditional Expression (3) represented by

$$55 < v 1 pave < 95. \qquad ( 3 )$$

The first lens group preferably includes, in consecutive order from the position closest to the object side to the image side, the two positive lenses, a positive lens, and a negative lens.

An aperture stop is preferably disposed between the lens surface of the first lens group closest to the image side and a lens surface of the second lens group closest to the object side.

The first lens group preferably includes, in order from the object side to the image side, only six lenses consisting of the two positive lenses, a positive lens, a negative lens, a positive lens, and a negative lens as lenses.

The second lens group preferably includes at least one positive lens and at least one negative lens.

The second lens group may be configured to consist of one cemented lens in which a positive lens and a negative lens are cemented.

A lens component having a positive refractive power is preferably disposed adjacent to the object side of the lens component having the negative refractive power closest to the image side in the third lens group.

An aperture stop is preferably disposed between the lens surface of the first lens group closest to the image side and a lens surface of the second lens group closest to the object side, the lens surface of the first lens group closest to the image side and the lens surface of the second lens group closest to the object side preferably have concave shapes, and the imaging lens of the aspect preferably satisfies Conditional Expression (4) represented by

$$0.7 < ( RG 1 r - RG 2 f ) / f < 4. \qquad ( 4 )$$

A curvature radius of the lens surface of the first lens group closest to the image side is denoted by RG1r. A curvature radius of the lens surface of the second lens group closest to the object side is denoted by RG2f. A focal length of the imaging lens in the state where the infinite distance object is in focus is denoted by f.

In a case where a back focus of the imaging lens as an air conversion distance in the state where the infinite distance object is in focus is denoted by Bf, and a focal length of the imaging lens in the state where the infinite distance object is in focus is denoted by f, the imaging lens of the aspect preferably satisfies Conditional Expression (5) represented by

$$0.7 < Bf / ( f \times tan ω m ) < 3. \qquad ( 5 )$$

In a case where a focal length of the imaging lens in the state where the infinite distance object is in focus is denoted by f, and a focal length of the lens component having the negative refractive power closest to the image side in the third lens group is denoted by fLe1, the imaging lens of the aspect preferably satisfies Conditional Expression (6) represented by

$$- 3.2 < f / fLe 1 < - 0.6 . \qquad ( 6 )$$

In a case where a lateral magnification of the second lens group in the state where the infinite distance object is in focus is denoted by β2, and a lateral magnification of the third lens group in the state where the infinite distance object is in focus is denoted by β3, the imaging lens of the aspect preferably satisfies Conditional Expression (7) represented by

$$1.3 < \vert ( 1 - {β2}^{2} ) \times β {3}^{2} \vert < 3.5 . \qquad ( 7 )$$

In a case where a sum of DA and a back focus of the imaging lens as an air conversion distance in the state where the infinite distance object is in focus is denoted by TL, the imaging lens of the aspect preferably satisfies Conditional Expression (8) represented by

$$0.1 < DG 1 / TL < 0.3 . \qquad ( 8 )$$

In a case where a height of an on-axis marginal ray from the optical axis on the lens surface of the first lens group closest to the image side in the state where the infinite distance object is in focus is denoted by H1r, and a height of an on-axis marginal ray from the optical axis on the lens surface of the first lens group closest to the object side in the state where the infinite distance object is in focus is denoted by H1f, the imaging lens of the aspect preferably satisfies Conditional Expression (9) represented by

$$0.5 < H 1 r / H 1 f < 0 \text{.85} . \qquad ( 9 )$$

In a case where a distance on the optical axis from the lens surface of the first lens group closest to the object side to a paraxial entrance pupil position in the state where the infinite distance object is in focus is denoted by Den, and a focal length of the imaging lens in the state where the infinite distance object is in focus is denoted by f, the imaging lens of the aspect preferably satisfies Conditional Expression (10) represented by

$$0.2 < Den / f < 0.5 . \qquad ( 10 )$$

In a case where a focal length of the imaging lens in the state where the infinite distance object is in focus is denoted by f, and a focal length of the first lens group is denoted by f1, the imaging lens of the aspect preferably satisfies Conditional Expression (11) represented by

$$1.2 < f / f 1 < 2. \qquad ( 11 )$$

In a case where a focal length of the imaging lens in the state where the infinite distance object is in focus is denoted by f, and a focal length of the second lens group is denoted by f2, the imaging lens of the aspect preferably satisfies Conditional Expression (12) represented by

$$- 3 < f / f 2 < - 1.3 . \qquad ( 12 )$$

In a case where a focal length of the imaging lens in the state where the infinite distance object is in focus is denoted by f, and a focal length of the third lens group is denoted by f3, the imaging lens of the aspect preferably satisfies Conditional Expression (13) represented by

$$0.8 < f / f 3 < 2.5 . \qquad ( 13 )$$

In a case where a distance on the optical axis from a lens surface of the second lens group closest to the object side to a lens surface of the second lens group closest to the image side is denoted by DG2, and a sum of DA and a back focus of the imaging lens as an air conversion distance in the state where the infinite distance object is in focus is denoted by TL, the imaging lens of the aspect preferably satisfies Conditional Expression (14) represented by

$$0.02 < DG 2 / TL < 0.1 . \qquad ( 14 )$$

According to another aspect of the present disclosure, there is provided an imaging apparatus comprising the imaging lens of the aspect.

In the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the illustrated constituents.

The term “group having a positive refractive power” in the present specification means that the entire group has a positive refractive power. The term “group having a negative refractive power” means that the entire group has a negative refractive power. The term “lens having a positive refractive power” and the term “positive lens” are synonymous with each other. The term “lens having a negative refractive power” and the term “negative lens” are synonymous with each other. The term “group” in the present specification is not limited to a configuration consisting of a plurality of lenses and may be a configuration consisting of only one lens.

A compound aspherical lens (a lens functioning as one aspherical lens as a whole, in which a lens (for example, a spherical lens) and a film of an aspherical shape formed on the lens are configured to be integrated with each other) is not regarded as a cemented lens and is regarded as one lens. Unless otherwise specified, a curvature radius, a sign of a refractive power, and a surface shape related to a lens including an aspherical surface in a paraxial region are used. For a sign of the curvature radius, a sign of the curvature radius of a surface having a convex shape facing the object side is positive, and a sign of the curvature radius of a surface having a convex shape facing the image side is negative.

The term “focal length” used in the conditional expressions is a paraxial focal length. Unless otherwise specified, the term “distance on the optical axis” used in the conditional expressions is a geometrical distance. Unless otherwise specified, values used in the conditional expressions are values based on the d line in the state where the infinite distance object is in focus.

The terms “d line”, “C line”, “F line”, and “g line” described in the present specification mean bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

According to the present disclosure, an imaging lens that has a large image circle and a small F-number and that is configured to be further reduced in size and favorably corrected in terms of aberrations, and an imaging apparatus comprising the imaging lens can be provided.

### BRIEF DESCRIPTION OF THE DRAWINGS

FIG. 1 is a cross-sectional view that illustrates a configuration of an imaging lens according to one embodiment and that corresponds to an imaging lens of Example 1.

FIG. 2 is a cross-sectional view illustrating a configuration and luminous fluxes in each state of the imaging lens in FIG. 1.

FIG. 3 is a diagram for describing symbols of conditional expressions.

FIG. 4 is each aberration diagram of the imaging lens of Example 1.

FIG. 5 is a cross-sectional view illustrating a configuration of an imaging lens of Example 2.

FIG. 6 is each aberration diagram of the imaging lens of Example 2.

FIG. 7 is a cross-sectional view illustrating a configuration of an imaging lens of Example 3.

FIG. 8 is each aberration diagram of the imaging lens of Example 3.

FIG. 9 is a cross-sectional view illustrating a configuration of an imaging lens of Example 4.

FIG. 10 is each aberration diagram of the imaging lens of Example 4.

FIG. 11 is a cross-sectional view illustrating a configuration of an imaging lens of Example 5.

FIG. 12 is each aberration diagram of the imaging lens of Example 5.

FIG. 13 is a cross-sectional view illustrating a configuration of an imaging lens of Example 6.

FIG. 14 is each aberration diagram of the imaging lens of Example 6.

FIG. 15 is a cross-sectional view illustrating a configuration of an imaging lens of Example 7.

FIG. 16 is each aberration diagram of the imaging lens of Example 7.

FIG. 17 is a cross-sectional view illustrating a configuration of an imaging lens of Example 8.

FIG. 18 is each aberration diagram of the imaging lens of Example 8.

FIG. 19 is a cross-sectional view illustrating a configuration of an imaging lens of Example 9.

FIG. 20 is each aberration diagram of the imaging lens of Example 9.

FIG. 21 is a cross-sectional view illustrating a configuration of an imaging lens of Example 10.

FIG. 22 is each aberration diagram of the imaging lens of Example 10.

FIG. 23 is a cross-sectional view illustrating a configuration of an imaging lens of Example 11.

FIG. 24 is each aberration diagram of the imaging lens of Example 11.

FIG. 25 is a cross-sectional view illustrating a configuration of an imaging lens of Example 12.

FIG. 26 is each aberration diagram of the imaging lens of Example 12.

FIG. 27 is a cross-sectional view illustrating a configuration of an imaging lens of Example 13.

FIG. 28 is each aberration diagram of the imaging lens of Example 13.

FIG. 29 is a perspective view of a front surface side of an imaging apparatus according to one embodiment.

FIG. 30 is a perspective view of a rear surface side of the imaging apparatus according to one embodiment.

### DETAILED DESCRIPTION

Hereinafter, an embodiment of the disclosed technology will be described with reference to the drawings.

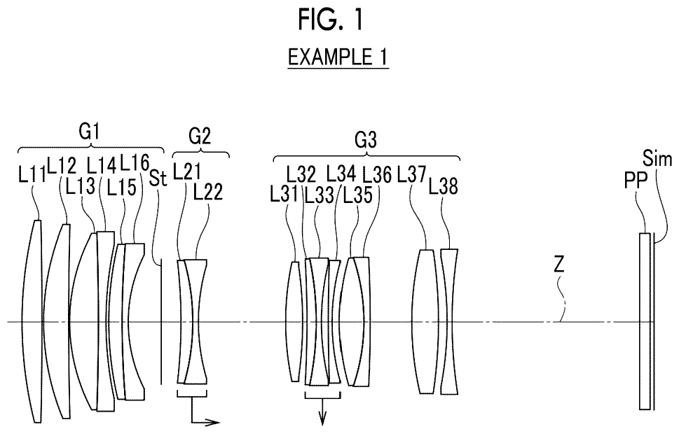

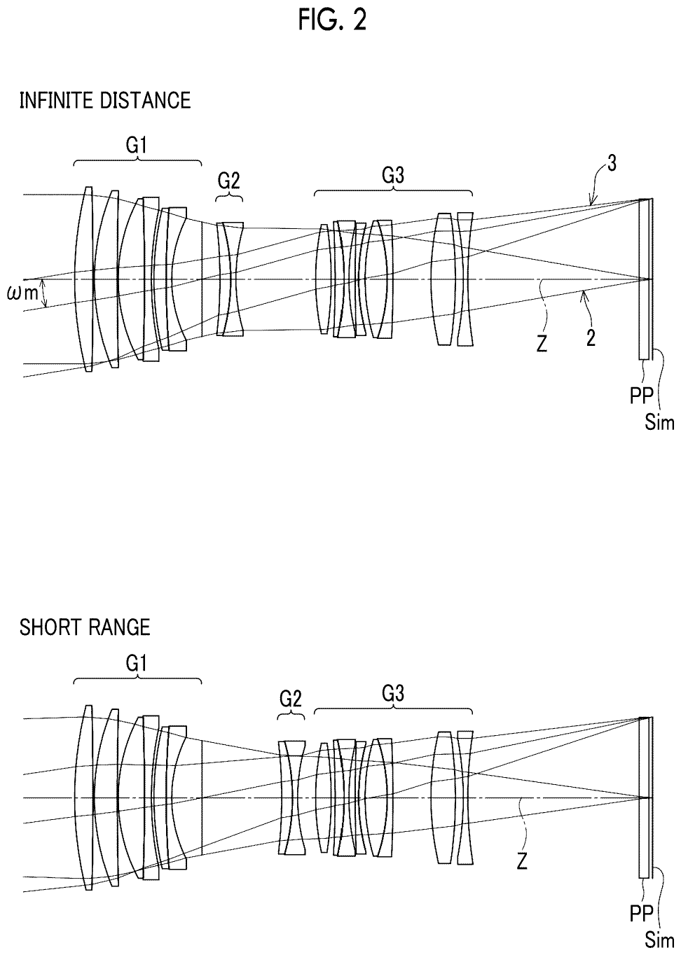

FIG. 1 illustrates a cross-sectional view of a configuration of an imaging lens according to one embodiment of the present disclosure in a state where an infinite distance object is in focus. FIG. 2 illustrates a cross-sectional view of the configuration and luminous fluxes of the imaging lens in FIG. 1 in each focus state. In FIG. 2, a state where the infinite distance object is in focus is illustrated in an upper part labeled “INFINITE DISTANCE”, and a state where a short range object is in focus is illustrated in a lower part labeled “SHORT RANGE”. In FIG. 2, an on-axis luminous flux 2 and a luminous flux 3 at a maximum half angle of view ωm in the state where the infinite distance object is in focus, and an on-axis luminous flux and a luminous flux at the maximum half angle of view in the state where the short range object is in focus are illustrated as the luminous fluxes. In FIGS. 1 and 2, a left side is an object side, and a right side is an image side. The examples illustrated in FIGS. 1 and 2 correspond to an imaging lens of Example 1 described later. Hereinafter, description will be mainly provided with reference to FIG. 1.

FIG. 1 illustrates an example in which an optical member PP having a shape of a parallel flat plate is disposed between the imaging lens and an image plane Sim, assuming that the imaging lens is applied to an imaging apparatus. The optical member PP is a member that is assumed to be various filters and/or a cover glass or the like. The various filters include a low-pass filter, an infrared cut filter, and/or a filter or the like that cuts a specific wavelength range. The optical member PP is a member not having a refractive power. The imaging apparatus can also be configured without the optical member PP.

An imaging lens of the present disclosure consists of, in order from the object side to the image side along an optical axis Z, a first lens group G1 having a positive refractive power, a second lens group G2 having a negative refractive power, and a third lens group G3 having a positive refractive power. Such a configuration achieves an advantage in size reduction of the entire lens system.

For example, each group of the imaging lens in FIG. 1 is configured as follows. The first lens group G1 consists of, in order from the object side to the image side, six lenses including lenses L11 to L16, and an aperture stop St. The second lens group G2 consists of, in order from the object side to the image side, two lenses including lenses L21 and L22. The third lens group G3 consists of, in order from the object side to the image side, eight lenses including lenses L31 to L38. The aperture stop St in FIG. 1 does not indicate a size or a shape and indicates a position in an optical axis direction.

In FIG. 1, a horizontal arrow indicating a moving direction during focusing from the infinite distance object to the short range object is illustrated below a focus group. The term “focus group” in the present specification means a group that moves along the optical axis Z during focusing. In the example in FIG. 1, the focus group consists of only the second lens group G2. The bracket and the rightward arrow below the second lens group G2 in FIG. 1 indicate that the second lens group G2 is the focus group and that the second lens group G2 moves to the image side during the focusing from the infinite distance object to the short range object.

In the imaging lens of the present disclosure, at least the second lens group G2 moves along the optical axis Z during the focusing. Configuring the focusing to be performed by moving at least the second lens group G2 can achieve weight reduction of the focus group and high-speed focusing.

While the imaging lens of the example in FIG. 1 includes only one focus group, the imaging lens of the present disclosure may be configured to include a plurality of focus groups that move along the optical axis Z while changing intervals between each other during the focusing. In the disclosed technology, in a case where the imaging lens includes one or a plurality of focus groups, the focus group closest to the object side among the one or the plurality of focus groups is the second lens group G2. In the imaging lens of the present disclosure, a group consisting of all optical elements closer to the object side than the second lens group G2 is the first lens group G1, and a group consisting of all optical elements closer to the image side than the second lens group G2 is the third lens group G3. The term “optical element” includes a lens, the aperture stop St, and the like.

As in the example in FIG. 1, configuring the imaging lens to include only one focus group achieves an advantage in weight reduction of the entire lens system. Configuring the imaging lens to include a plurality of focus groups achieves an advantage in suppressing fluctuation of aberrations during the focusing. For example, in the imaging lens of the present disclosure, during the focusing, the entire second lens group G2 and a part of the third lens group G3 may be configured to move along the optical axis Z by changing intervals between each other. Doing so achieves an advantage in improving optical performance in the state where the short range object is in focus.

The first lens group G1 is configured to include, in consecutive order from a position closest to the object side to the image side, two positive lenses. This configuration achieves an advantage in favorably correcting a spherical aberration and an axial chromatic aberration while reducing the optical system in size.

The first lens group G1 may be configured to include, in consecutive order from the position closest to the object side to the image side, a positive lens, a positive lens, a positive lens, and a negative lens. Doing so achieves an advantage in favorably correcting the spherical aberration and the axial chromatic aberration while reducing the optical system in size.

For example, the first lens group G1 may be configured to include, in order from the object side to the image side, only six lenses consisting of a positive lens, a positive lens, a positive lens, a negative lens, a positive lens, and a negative lens as lenses. Doing so achieves an advantage in favorably correcting the spherical aberration and the axial chromatic aberration. In a case where the first lens group G1 includes the six lenses, the first lens group G1 may be configured to include a cemented lens in which a positive lens and a negative lens are cemented. Doing so achieves an advantage in correcting a chromatic aberration. In order to obtain more favorable characteristics, the first lens group G1 preferably includes two cemented lenses.

The second lens group G2 preferably includes at least one positive lens and at least one negative lens. Doing so achieves an advantage in suppressing fluctuation of the axial chromatic aberration during the focusing.

The second lens group G2 may be configured to consist of one cemented lens in which a positive lens and a negative lens are cemented. Doing so achieves an advantage in weight reduction of the focus group while suppressing fluctuation of the axial chromatic aberration during the focusing.

The third lens group G3 is configured to include a lens component having a negative refractive power at a position closest to the image side. This configuration achieves an advantage in reduction of a total length of the lens system. In the present specification, one lens component is one single lens or one cemented lens. The term “single lens” means one non-cemented lens.

A lens component having a positive refractive power is preferably disposed adjacent to the object side of the lens component having the negative refractive power closest to the image side in the third lens group G3. Doing so achieves an advantage in reduction of the total length of the lens system.

The third lens group G3 preferably includes at least one cemented lens and a single lens having a negative refractive power. Doing so achieves an advantage in reduction of the total length of the lens system while favorably correcting a lateral chromatic aberration.

The number of lenses included in the third lens group G3 is preferably 4 or more. Doing so achieves an advantage in correcting an astigmatism. In order to obtain more favorable characteristics, the number of lenses included in the third lens group G3 is more preferably 5 or more and further preferably 6 or more.

The number of lenses included in the third lens group G3 is preferably 13 or less. Doing so achieves an advantage in weight reduction of the optical system and reduction of the total length of the lens system. In order to obtain more favorable characteristics, the number of lenses included in the third lens group G3 is more preferably 12 or less, further preferably 11 or less, and further preferably 10 or less.

The imaging lens preferably includes the aperture stop St, and a lens surface adjacent to the object side of the aperture stop St and a lens surface adjacent to the image side of the aperture stop St preferably have concave shapes. Doing so provides a biconvex shape of an air lens formed by two lens surfaces facing each other with the aperture stop St interposed therebetween and thus, facilitates suitable correction of the spherical aberration and the astigmatism. In the present specification, an air spacing interposed between two lens surfaces facing each other is regarded as a lens having a refractive index of 1, and the air spacing will be referred to as the air lens.

The aperture stop St may be configured to be disposed between a lens surface of the first lens group G1 closest to the image side and a lens surface of the second lens group G2 closest to the object side. Disposing the aperture stop St at a position relatively close to the object side can reduce an outer diameter of the lens on the object side and thus, can contribute to weight reduction of the optical system.

The imaging lens may be configured to include a vibration-proof group that moves in a direction intersecting with the optical axis Z during image shake correction. In a case where the imaging lens includes the vibration-proof group, the vibration-proof group is preferably disposed in the third lens group G3. Providing the vibration-proof group in a part having a relatively small lens outer diameter achieves an advantage in reduction of a diameter of the entire lens system.

In a case where the vibration-proof group is disposed in the third lens group G3, the third lens group G3 preferably includes a fixed group that has a refractive power having a sign opposite to a sign of a refractive power of the vibration-proof group and does not move during the image shake correction and that is disposed on the object side of the vibration-proof group. Doing so can improve vibration-proof sensitivity of the vibration-proof group (that is, an image shake correction amount per unit moving amount of the vibration-proof group) and thus, achieves an advantage in reduction of the diameter of the optical system.

The third lens group G3 may consist of, in order from the object side to the image side, a first partial group having a positive refractive power, a second partial group having a negative refractive power, and a third partial group having a positive refractive power, and during the image shake correction, only the second partial group may be configured to move in a direction intersecting with the optical axis Z. That is, the vibration-proof group may be configured to consist of the second partial group. Forming the vibration-proof group as a group having a negative refractive power and disposing the vibration-proof group between groups having a positive refractive power and not moving during the image shake correction can improve the vibration-proof sensitivity and thus, achieve an advantage in reduction of the diameter of the optical system. In a case where the third lens group G3 is fixed with respect to the image plane Sim during the focusing, providing the vibration-proof group in the third lens group G3 that does not move during the focusing can contribute to simplification of a mechanical structure.

In the example in FIG. 1, a group consisting of the lens L31 corresponds to the first partial group, a group consisting of the lenses L32 to L34 corresponds to the second partial group, and a group consisting of the lenses L35 to L38 corresponds to the third partial group. A bracket and a downward arrow below the lenses L32 to L34 in FIG. 1 indicate that the lenses L32 to L34 are the vibration-proof group.

The vibration-proof group preferably includes a cemented lens in which a positive lens and a negative lens are cemented. Doing so achieves an advantage in correcting color bleeding during the image shake correction. Providing the cemented lens facilitates high-accuracy assembly.

The vibration-proof group may be configured to consist of a cemented lens and a single lens. Doing so achieves an advantage in correcting color bleeding during the image shake correction.

Hereinafter, preferable configurations of the imaging lens of the present disclosure related to conditional expressions will be described. In the following description of the conditional expressions, in order to avoid redundancy, the same symbol will be used for the same definition to omit duplicate descriptions of the symbol. Hereinafter, the “imaging lens of the present disclosure” will be simply referred to as the “imaging lens” in order to avoid redundancy.

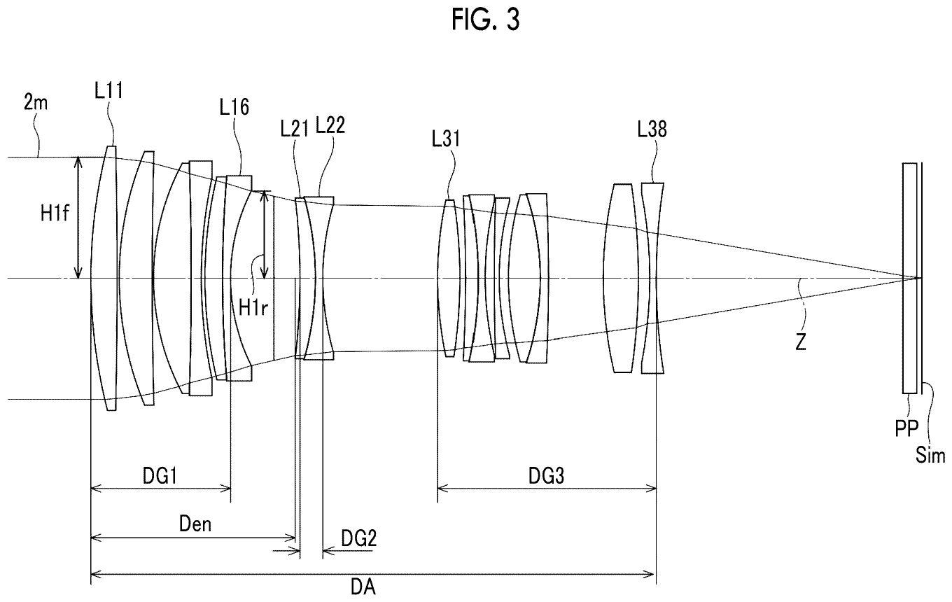

The imaging lens preferably satisfies Conditional Expression (1). A distance on the optical axis from a lens surface of the first lens group G1 closest to the object side to the lens surface of the first lens group G1 closest to the image side is denoted by DG1. A distance on the optical axis from the lens surface of the first lens group G1 closest to the object side to a lens surface of the third lens group G3 closest to the image side in the state where the infinite distance object is in focus is denoted by DA. FIG. 3 illustrates the imaging lens in FIG. 1 and, for example, illustrates the distance DG1 and the distance DA. In FIG. 3, reference numerals of a part of lenses are omitted. Ensuring that a corresponding value of Conditional Expression (1) is not less than or equal to its lower limit value achieves an advantage in correcting the spherical aberration. Ensuring that the corresponding value of Conditional Expression (1) is not greater than or equal to its upper limit value achieves an advantage in weight reduction of the optical system and reduction of the total length of the lens system.

$$0.14 < DG 1 / DA < 0.5 \qquad ( 1 )$$

In order to obtain more favorable characteristics, the lower limit value of Conditional Expression (1) is more preferably 0.16, further preferably 0.18, and further preferably 0.2. In order to obtain more favorable characteristics, the upper limit value of Conditional Expression (1) is more preferably 0.4, further preferably 0.35, and further preferably 0.3.

The imaging lens preferably satisfies Conditional Expression (2). A maximum half angle of view in the state where the infinite distance object is in focus is denoted by ωm. Here, ωm is in degree units. An open F-number in the state where the infinite distance object is in focus is denoted by Fno. For example, FIG. 2 illustrates the maximum half angle of view ωm. Ensuring that a corresponding value of Conditional Expression (2) is not less than or equal to its lower limit value facilitates reduction of the open F-number while securing a large image circle by increasing an angle of view. Ensuring that the corresponding value of Conditional Expression (2) is not greater than or equal to its upper limit value achieves an advantage in suppressing an increase in the number of lenses and suppressing size increase of the optical system while obtaining favorable optical performance.

$$0.02 < ( tan ω m ) / Fno < 0 \text{.15} \qquad ( 2 )$$

In order to obtain more favorable characteristics, the lower limit value of Conditional Expression (2) is more preferably 0.03, further preferably 0.04, and further preferably 0.05. In order to obtain more favorable characteristics, the upper limit value of Conditional Expression (2) is more preferably 0.1, further preferably 0.09, and further preferably 0.085.

The imaging lens preferably satisfies Conditional Expression (3). An average value of Abbe numbers based on a d line for all positive lenses included in the first lens group G1 is denoted by v1pave. Ensuring that a corresponding value of Conditional Expression (3) is not less than or equal to its lower limit value achieves an advantage in favorably correcting the axial chromatic aberration. Ensuring that the corresponding value of Conditional Expression (3) is not greater than or equal to its upper limit value increases obtainability of materials and thus, enables use of materials that are more easily manufacturable.

$$55 < v 1 pave < 95 \qquad ( 3 )$$

In order to obtain more favorable characteristics, the lower limit value of Conditional Expression (3) is more preferably 60, further preferably 63, and further preferably 65. In order to obtain more favorable characteristics, the upper limit value of Conditional Expression (3) is more preferably 90, further preferably 80, and further preferably 78.

In the configuration in which the aperture stop St is disposed between the lens surface of the first lens group G1 closest to the image side and the lens surface of the second lens group G2 closest to the object side, and the lens surface of the first lens group G1 closest to the image side and the lens surface of the second lens group G2 closest to the object side have concave shapes, the imaging lens preferably satisfies Conditional Expression (4). A curvature radius of the lens surface of the first lens group G1 closest to the image side is denoted by RG1r. A curvature radius of the lens surface of the second lens group G2 closest to the object side is denoted by RG2f. A focal length of the imaging lens in the state where the infinite distance object is in focus is denoted by f. Satisfying Conditional Expression (4) can prevent a refractive power of one surface forming the air lens including the aperture stop St from being excessively strong or excessively weak with respect to a refractive power of the other surface and thus, facilitates suitable correction of the spherical aberration.

$$0.7 < ( RG 1 r - RG 2 f ) / f < 4 \qquad ( 4 )$$

In order to obtain more favorable characteristics, a lower limit value of Conditional Expression (4) is more preferably 0.8, further preferably 0.9, and further preferably 1. In order to obtain more favorable characteristics, an upper limit value of Conditional Expression (4) is more preferably 3.5, further preferably 3, and further preferably 2.8.

The imaging lens preferably satisfies Conditional Expression (5). A back focus of the imaging lens as an air conversion distance in the state where the infinite distance object is in focus is denoted by Bf. Ensuring that a corresponding value of Conditional Expression (5) is not less than or equal to its lower limit value can suppress an increase in an incidence angle of a principal ray of an off-axis luminous flux on the image plane Sim and thus, achieves an advantage in suppressing occurrence of color shading. Ensuring that the corresponding value of Conditional Expression (5) is not greater than or equal to its upper limit value prevents an excessively long back focus and thus, achieves an advantage in reduction of the total length of the lens system.

$$0.7 < Bf / ( f \times tan ω m ) < 3 \qquad ( 5 )$$

In order to obtain more favorable characteristics, the lower limit value of Conditional Expression (5) is more preferably 0.85, further preferably 1, and further preferably 2.1. In order to obtain more favorable characteristics, the upper limit value of Conditional Expression (5) is more preferably 2.6, further preferably 2.4, and further preferably 2.35.

The imaging lens preferably satisfies Conditional Expression (6). A focal length of the lens component having the negative refractive power closest to the image side in the third lens group G3 is denoted by fLe1. Ensuring that a corresponding value of Conditional Expression (6) is not less than or equal to its lower limit value achieves an advantage in correcting a distortion. Ensuring that the corresponding value of Conditional Expression (6) is not greater than or equal to its upper limit value can secure the negative refractive power of the lens component closest to the image side in the third lens group G3 and thus, achieves an advantage in suppressing an increase in a diameter of a lens closest to the image side.

$$- 3.2 < f / fLe 1 < - 0.6 \qquad ( 6 )$$

In order to obtain more favorable characteristics, the lower limit value of Conditional Expression (6) is more preferably −2.9, further preferably −2.7, and further preferably −2.5. In order to obtain more favorable characteristics, the upper limit value of Conditional Expression (6) is more preferably −0.7, further preferably −0.75, and further preferably −0.8.

The imaging lens preferably satisfies Conditional Expression (7). A lateral magnification of the second lens group G2 in the state where the infinite distance object is in focus is denoted by β2. A lateral magnification of the third lens group G3 in the state where the infinite distance object is in focus is denoted by β3. Ensuring that a corresponding value of Conditional Expression (7) is not less than or equal to its lower limit value can reduce a moving amount of the second lens group G2 during the focusing and thus, achieves an advantage in reduction of the total length of the lens system. Ensuring that the corresponding value of Conditional Expression (7) is not greater than or equal to its upper limit value can suppress fluctuation of the spherical aberration and fluctuation of a field curvature during the focusing.

$$1.3 \text{<\textbar} ( 1 - {β2}^{2} ) \times β {3}^{2} \vert < 3.5 \qquad ( 7 )$$

In order to obtain more favorable characteristics, the lower limit value of Conditional Expression (7) is more preferably 1.5, further preferably 1.6, and further preferably 1.65. In order to obtain more favorable characteristics, the upper limit value of Conditional Expression (7) is more preferably 3, further preferably 2.8, and further preferably 2.65.

The imaging lens preferably satisfies Conditional Expression (8). A sum of DA and the back focus of the imaging lens as the air conversion distance in the state where the infinite distance object is in focus is denoted by TL. Ensuring that a corresponding value of Conditional Expression (8) is not less than or equal to its lower limit value achieves an advantage in favorably correcting the axial chromatic aberration. Ensuring that the corresponding value of Conditional Expression (8) is not greater than or equal to its upper limit value achieves an advantage in reduction of the total length of the lens system and weight reduction.

$$0.1 < DG 1 / TL < 0.3 \qquad ( 8 )$$

In order to obtain more favorable characteristics, the lower limit value of Conditional Expression (8) is more preferably 0.12, further preferably 0.13, and further preferably 0.15. In order to obtain more favorable characteristics, the upper limit value of Conditional Expression (8) is more preferably 0.26, further preferably 0.24, and further preferably 0.22.

The imaging lens preferably satisfies Conditional Expression (9). A height of an on-axis marginal ray from the optical axis Z on the lens surface of the first lens group G1 closest to the image side in the state where the infinite distance object is in focus is denoted by H1r. A height of an on-axis marginal ray from the optical axis Z on the lens surface of the first lens group G1 closest to the object side in the state where the infinite distance object is in focus is denoted by H1f. For example, FIG. 3 illustrates an on-axis marginal ray 2m, the height H1r, and the height H1f. Ensuring that a corresponding value of Conditional Expression (9) is not less than or equal to its lower limit value prevents an excessively strong condensing action of only the first lens group G1 and thus, achieves an advantage in correcting the spherical aberration. Ensuring that the corresponding value of Conditional Expression (9) is not greater than or equal to its upper limit value can suppress an increase in an outer diameter of the first lens group G1 and thus, achieves an advantage in weight reduction.

$$0.5 < H 1 r / H 1 f < 0 \text{.85} \qquad ( 9 )$$

In order to obtain more favorable characteristics, the lower limit value of Conditional Expression (9) is more preferably 0.55, further preferably 0.6, and further preferably 0.65. In order to obtain more favorable characteristics, the upper limit value of Conditional Expression (9) is more preferably 0.8, further preferably 0.78, and further preferably 0.75.

The imaging lens preferably satisfies Conditional Expression (10). A distance on the optical axis from the lens surface of the first lens group G1 closest to the object side to a paraxial entrance pupil position in the state where the infinite distance object is in focus is denoted by Den. For example, FIG. 3 illustrates the distance Den. Ensuring that a corresponding value of Conditional Expression (10) is not less than or equal to its lower limit value achieves an advantage in suppressing the distortion. Ensuring that the corresponding value of Conditional Expression (10) is not greater than or equal to its upper limit value achieves an advantage in size reduction of the first lens group G1.

$$0.2 < Den / f < 0.5 \qquad ( 10 )$$

In order to obtain more favorable characteristics, the lower limit value of Conditional Expression (10) is more preferably 0.22, further preferably 0.24, and further preferably 0.25. In order to obtain more favorable characteristics, the upper limit value of Conditional Expression (10) is more preferably 0.45, further preferably 0.4, and further preferably 0.35.

In a case where a focal length of the first lens group G1 is denoted by f1, the imaging lens preferably satisfies Conditional Expression (11). Ensuring that a corresponding value of Conditional Expression (11) is not less than or equal to its lower limit value prevents an excessively weak refractive power of the first lens group G1 and thus, achieves an advantage in reduction of the total length of the lens system. Ensuring that the corresponding value of Conditional Expression (11) is not greater than or equal to its upper limit value prevents an excessively strong refractive power of the first lens group G1 and thus, achieves an advantage in suppressing fluctuation of the aberrations during the focusing.

$$1.2 < f / f 1 < 2 \qquad ( 11 )$$

In order to obtain more favorable characteristics, the lower limit value of Conditional Expression (11) is more preferably 1.23, further preferably 1.25, and further preferably 1.29. In order to obtain more favorable characteristics, the upper limit value of Conditional Expression (11) is more preferably 1.8, further preferably 1.67, and further preferably 1.62.

In a case where a focal length of the second lens group G2 is denoted by f2, the imaging lens preferably satisfies Conditional Expression (12). Ensuring that a corresponding value of Conditional Expression (12) is not less than or equal to its lower limit value can suppress fluctuation of the spherical aberration and fluctuation of the field curvature during the focusing. Ensuring that the corresponding value of Conditional Expression (12) is not greater than or equal to its upper limit value can reduce the moving amount of the second lens group G2 during the focusing and thus, achieves an advantage in reduction of the total length of the lens system.

$$- 3 < f / f 2 < - 1.3 \qquad ( 12 )$$

In order to obtain more favorable characteristics, the lower limit value of Conditional Expression (12) is more preferably −2.8, further preferably −2.7, and further preferably −2.65. In order to obtain more favorable characteristics, the upper limit value of Conditional Expression (12) is more preferably −1.5, further preferably −1.7, and further preferably −1.9.

In a case where a focal length of the third lens group G3 is denoted by f3, the imaging lens preferably satisfies Conditional Expression (13). Ensuring that a corresponding value of Conditional Expression (13) is not less than or equal to its lower limit value facilitates further reduction of the incidence angle of the principal ray on the image plane Sim. Ensuring that the corresponding value of Conditional Expression (13) is not greater than or equal to its upper limit value achieves an advantage in reduction of the total length of the lens system.

$$0.8 < f / f 3 < 2.5 \qquad ( 13 )$$

In order to obtain more favorable characteristics, the lower limit value of Conditional Expression (13) is more preferably 1, further preferably 1.2, and further preferably 1.3. In order to obtain more favorable characteristics, the upper limit value of Conditional Expression (13) is more preferably 2, further preferably 1.8, and further preferably 1.65.

The imaging lens preferably satisfies Conditional Expression (14). A distance on the optical axis from the lens surface of the second lens group G2 closest to the object side to a lens surface of the second lens group G2 closest to the image side is denoted by DG2. For example, FIG. 3 illustrates the distance DG2. Ensuring that a corresponding value of Conditional Expression (14) is not less than or equal to its lower limit value can suppress fluctuation of the spherical aberration and fluctuation of the field curvature during the focusing. Ensuring that the corresponding value of Conditional Expression (14) is not greater than or equal to its upper limit value achieves an advantage in reduction of the total length of the lens system and weight reduction.

$$0.02 < DG 2 / TL < 0.1 \qquad ( 14 )$$

In order to obtain more favorable characteristics, the lower limit value of Conditional Expression (14) is more preferably 0.022, further preferably 0.024, and further preferably 0.026. In order to obtain more favorable characteristics, the upper limit value of Conditional Expression (14) is more preferably 0.07, further preferably 0.05, and further preferably 0.033.

The imaging lens preferably satisfies Conditional Expression (15). A combined focal length of the second lens group G2 and the third lens group G3 in the state where the infinite distance object is in focus is denoted by f23. Ensuring that a corresponding value of Conditional Expression (15) is not less than or equal to its lower limit value achieves an advantage in size reduction of the lens system. Ensuring that the corresponding value of Conditional Expression (15) is not greater than or equal to its upper limit value achieves an advantage in correcting the spherical aberration.

$$- 1.5 < f 1 / f 23 < - 0.01 \qquad ( 15 )$$

In order to obtain more favorable characteristics, the lower limit value of Conditional Expression (15) is more preferably −1.2, further preferably −0.9, and further preferably −0.8. In order to obtain more favorable characteristics, the upper limit value of Conditional Expression (15) is more preferably −0.011, further preferably −0.012, and further preferably −0.013.

The imaging lens preferably satisfies Conditional Expression (16). A distance on the optical axis from a lens surface of the third lens group G3 closest to the object side to the lens surface of the third lens group G3 closest to the image side is denoted by DG3. For example, FIG. 3 illustrates the distance DG3. Ensuring that a corresponding value of Conditional Expression (16) is not less than or equal to its lower limit value achieves an advantage in correcting the field curvature. Ensuring that the corresponding value of Conditional Expression (16) is not greater than or equal to its upper limit value achieves an advantage in reduction of the total length of the lens system and weight reduction.

$$0.15 < DG 3 / TL < 0.5 \qquad ( 16 )$$

In order to obtain more favorable characteristics, the lower limit value of Conditional Expression (16) is more preferably 0.18, further preferably 0.21, and further preferably 0.23. In order to obtain more favorable characteristics, the upper limit value of Conditional Expression (16) is more preferably 0.45, further preferably 0.42, and further preferably 0.39.

The imaging lens preferably satisfies Conditional Expression (17). Ensuring that a corresponding value of Conditional Expression (17) is not less than or equal to its lower limit value prevents an excessively strong refractive power of the first lens group G1 and thus, achieves an advantage in suppressing the field curvature. Ensuring that the corresponding value of Conditional Expression (17) is not greater than or equal to its upper limit value achieves an advantage in reduction of the total length of the lens system.

$$- 0.85 < f 2 / f 1 < - 0.4 \qquad ( 17 )$$

In order to obtain more favorable characteristics, the lower limit value of Conditional Expression (17) is more preferably −0.8, further preferably −0.75, and further preferably −0.72. In order to obtain more favorable characteristics, the upper limit value of Conditional Expression (17) is more preferably −0.5, further preferably −0.55, and further preferably −0.61.

The imaging lens preferably satisfies Conditional Expression (18). A curvature radius of a lens surface, closest to the object side, of the lens component having the negative refractive power closest to the image side in the third lens group G3 is denoted by RLe1f. A curvature radius of a lens surface, closest to the image side, of the lens component adjacent to the object side of the lens component having the negative refractive power closest to the image side in the third lens group G3 is denoted by RLe2r. Conditional Expression (18) is an expression related to an air lens formed by the lens surface, closest to the object side, of the lens component of the third lens group G3 closest to the image side and a lens surface adjacent to the object side of the lens surface. Satisfying Conditional Expression (18) can prevent a refractive power of one surface forming the air lens from being excessively strong or excessively weak with respect to a refractive power of the other surface. This enables the incidence angle of the principal ray of the off-axis luminous flux on the image plane Sim to be appropriately maintained and thus, achieves an advantage in favorably correcting the astigmatism.

$$- 7 < ( RLe 1 f + RLe 2 r ) / ( RLe 1 f - RLe 2 r ) < 2.5 \qquad ( 18 )$$

In order to obtain more favorable characteristics, the lower limit value of Conditional Expression (18) is more preferably −6.5, further preferably −6, and further preferably −5.85. In order to obtain more favorable characteristics, the upper limit value of Conditional Expression (18) is more preferably 2, further preferably 1.8, and further preferably 1.2.

The imaging lens preferably satisfies Conditional Expression (19). The curvature radius of the lens surface of the second lens group G2 closest to the object side is denoted by RG2f. A curvature radius of the lens surface of the second lens group G2 closest to the image side is denoted by RG2r. Ensuring that a corresponding value of Conditional Expression (19) is not less than or equal to its lower limit value can suppress occurrence of the astigmatism. Ensuring that the corresponding value of Conditional Expression (19) is not greater than or equal to its upper limit value achieves an advantage in correcting the spherical aberration.

$$0.3 < ( RG 2 f + RG 2 r ) / ( RG 2 f - RG 2 r ) < 1 \qquad ( 19 )$$

In order to obtain more favorable characteristics, the lower limit value of Conditional Expression (19) is more preferably 0.34, further preferably 0.36, and further preferably 0.39. In order to obtain more favorable characteristics, the upper limit value of Conditional Expression (19) is more preferably 0.9, further preferably 0.8, and further preferably 0.72.

The imaging lens preferably satisfies Conditional Expression (20). Ensuring that a corresponding value of Conditional Expression (20) is not less than or equal to its lower limit value facilitates disposition of an optimal number of lenses for correcting various aberrations and thus, achieves an advantage in obtaining higher image forming performance. Ensuring that the corresponding value of Conditional Expression (20) is not greater than or equal to its upper limit value achieves an advantage in suppressing an increase in a lens diameter.

$$2 < TL \times Fno / f < 4 \qquad ( 20 )$$

In order to obtain more favorable characteristics, the lower limit value of Conditional Expression (20) is more preferably 2.1, further preferably 2.3, and further preferably 2.4. In order to obtain more favorable characteristics, the upper limit value of Conditional Expression (20) is more preferably 3.8, further preferably 3.6, and further preferably 3.4.

The imaging lens preferably satisfies Conditional Expression (21). Ensuring that a corresponding value of Conditional Expression (21) is not less than or equal to its lower limit value achieves an advantage in preventing overcorrection of the field curvature. Ensuring that the corresponding value of Conditional Expression (21) is not greater than or equal to its upper limit value achieves an advantage in preventing undercorrection of the field curvature.

$$- 1.5 < f 2 / f 3 < - 0.45 \qquad ( 21 )$$

In order to obtain more favorable characteristics, the lower limit value of Conditional Expression (21) is more preferably −1, further preferably −0.8, and further preferably −0.76. In order to obtain more favorable characteristics, the upper limit value of Conditional Expression (21) is more preferably −0.5, further preferably −0.52, and further preferably −0.56.

The imaging lens preferably satisfies Conditional Expression (22). A focal length of the lens component adjacent to the object side of the lens component having the negative refractive power closest to the image side in the third lens group G3 is denoted by fLe2. Ensuring that a corresponding value of Conditional Expression (22) is not less than or equal to its lower limit value achieves an advantage in suppressing the field curvature. Ensuring that the corresponding value of Conditional Expression (22) is not greater than or equal to its upper limit value achieves an advantage in reduction of the total length of the lens system.

$$- 2 < fLe 2 / fLe 1 < - 0.4 \qquad ( 22 )$$

In order to obtain more favorable characteristics, the lower limit value of Conditional Expression (22) is more preferably −1.7, further preferably −1.5, and further preferably −1.3. In order to obtain more favorable characteristics, the upper limit value of Conditional Expression (22) is more preferably −0.45, further preferably −0.5, and further preferably −0.55.

In the configuration in which the imaging lens includes the vibration-proof group, the imaging lens preferably satisfies Conditional Expression (23). A focal length of the vibration-proof group is denoted by fIS. Ensuring that a corresponding value of Conditional Expression (23) is not less than or equal to its lower limit value prevents an excessively strong refractive power of the vibration-proof group and thus, achieves an advantage in suppressing a change in performance during the image shake correction. Ensuring that the corresponding value of Conditional Expression (23) is not greater than or equal to its upper limit value prevents an excessively weak refractive power of the vibration-proof group and thus, can reduce a moving amount of the vibration-proof group during the image shake correction. This achieves an advantage in weight reduction and reduction of the diameter of the optical system.

$$- 4 < f 3 / fIS {<}_{} - 0.6 \qquad ( 23 )$$

In order to obtain more favorable characteristics, the lower limit value of Conditional Expression (23) is more preferably −3.8, further preferably −3.4, and further preferably −3.2. In order to obtain more favorable characteristics, the upper limit value of Conditional Expression (23) is more preferably −0.8, further preferably −1, and further preferably −1.2.

The imaging lens preferably satisfies Conditional Expression (24). A focal length of a lens component closest to the object side in the third lens group G3 is denoted by f3F1. Ensuring that a corresponding value of Conditional Expression (24) is not less than or equal to its lower limit value prevents an excessively strong negative refractive power of the lens component closest to the object side in the third lens group G3 and thus, achieves an advantage in reduction of the total length of the lens system. Ensuring that the corresponding value of Conditional Expression (24) is not greater than or equal to its upper limit value prevents an excessively strong positive refractive power of the lens component closest to the object side in the third lens group G3 and thus, achieves an advantage in correcting the spherical aberration.

$$- 2 < f 3 / f 3 F 1 < 2 \qquad ( 24 )$$

In order to obtain more favorable characteristics, the lower limit value of Conditional Expression (24) is more preferably −1, further preferably −0.8, and further preferably −0.45. In order to obtain more favorable characteristics, the upper limit value of Conditional Expression (24) is more preferably 1.8, further preferably 1.7, and further preferably 1.6.

The imaging lens preferably satisfies Conditional Expression (25). An Abbe number based on a d line for a positive lens closest to the object side among positive lenses of the third lens group G3 is denoted by v3p. Ensuring that a corresponding value of Conditional Expression (25) is not less than or equal to its lower limit value achieves an advantage in favorably correcting the axial chromatic aberration. Ensuring that the corresponding value of Conditional Expression (25) is not greater than or equal to its upper limit value increases obtainability of materials and thus, enables use of materials that are more easily manufacturable.

$$55 < v 3 p < 105 \qquad ( 25 )$$

In order to obtain more favorable characteristics, the lower limit value of Conditional Expression (25) is more preferably 60, further preferably 63, and further preferably 65. In order to obtain more favorable characteristics, the upper limit value of Conditional Expression (25) is more preferably 100, further preferably 97, and further preferably 95.

The example illustrated in FIG. 1 is merely an example and can be subjected to various modifications without departing from the gist of the disclosed technology. For example, the number of lenses included in each group and the number of focus groups included in the imaging lens may be different from the numbers in the example in FIG. 1. Configurations of lenses included in each lens group can be different from the configurations in the example in FIG. 1.

The above preferable configurations and available configurations including the configurations related to the conditional expressions can be combined in any manner and are preferably selectively adopted, as appropriate, in accordance with required specifications.

For example, according to a preferable aspect of the present disclosure, an imaging lens consists of, in order from the object side to the image side, the first lens group G1 having a positive refractive power, the second lens group G2 having a negative refractive power, and the third lens group G3 having a positive refractive power, in which, during the focusing, at least the second lens group G2 moves along the optical axis Z, the second lens group G2 is a group closest to the object side among groups that move during the focusing, the first lens group G1 includes, in consecutive order from the position closest to the object side to the image side, two positive lenses, in a case where one lens component is one single lens or one cemented lens, the third lens group G3 includes a lens component having a negative refractive power closest to the image side, and Conditional Expressions (1) and (2) are satisfied.

Next, examples of the imaging lens of the present disclosure will be described with reference to the drawings. Reference numerals provided to the lens groups and the lenses in the cross-sectional view of each example are independently used for each example in order to avoid complication of description and the drawings caused by an increasing number of digits of the reference numerals. Accordingly, even in a case where a common reference numeral is provided in the drawings of different examples, the common reference numeral does not necessarily indicate a common configuration.

### Example 1

A cross-sectional view of a configuration of the imaging lens of Example 1 is illustrated in FIG. 1, and its illustration method and configuration are the same as described above. Thus, duplicate descriptions will be partially omitted. The imaging lens of Example 1 consists of, in order from the object side to the image side, the first lens group G1 having a positive refractive power, the second lens group G2 having a negative refractive power, and the third lens group G3 having a positive refractive power. The focus group consists of the second lens group G2, and the second lens group G2 moves to the image side along the optical axis Z during the focusing from the infinite distance object to the short range object. The vibration-proof group consists of the lenses L32 to L34.

For the imaging lens of Example 1, Table 1 shows basic lens data, Table 2 shows specifications, and Table 3 shows a variable surface spacing.

The table of the basic lens data is described as follows. A column of “Sn” shows surface numbers in a case where the number is increased by one at a time toward the image side from a first surface that is a surface closest to the object side. A column of “R” shows a curvature radius of each surface. A column of “D” shows a surface spacing on the optical axis between each surface and its adjacent surface on the image side. A column of “Nd” shows a refractive index with respect to a d line for each lens. A column of “vd” shows an Abbe number based on the d line for each lens.

In the table of the basic lens data, a sign of the curvature radius of the surface having a convex shape facing the object side is positive, and a sign of the curvature radius of the surface having a convex shape facing the image side is negative. A field of the surface number of the surface corresponding to the aperture stop St shows the surface number and a text (St). The table of the basic lens data also shows the optical member PP. A value in a lowermost field of the column of D in the table indicates a spacing between a surface closest to the image side in the table and the image plane Sim. A symbol DD [ ] is used for the variable surface spacing during the focusing. A surface number on the object side of the spacing is provided in [ ] in the column of the surface spacing.

Table 2 shows the focal length f, the back focus Bf as the air conversion distance, the open F-number Fno, and a maximum full angle of view 2om of the imaging lens based on a d line. In a field of the maximum full angle of view, [°] indicates a degree unit. Table 2 shows values in the state where the infinite distance object is in focus.

In Table 3, a column of “Infinite Distance” shows the variable surface spacing in the state where the infinite distance object is in focus. An uppermost field of a rightmost column shows an object distance of the short range object, and the column below the uppermost field shows the variable surface spacing in the state where the short range object is in focus. For example, in Example 1, the object distance of the short range object is 0.91 meters (m).

The term “object distance” means a distance on the optical axis from an object to a lens surface closest to the object side.

In the data of each table, a degree unit is used for angles, and a millimeter (mm) unit is used for lengths other than the object distance. However, since the optical system can also be proportionally enlarged or proportionally reduced to be used, other appropriate units can also be used. Numerical values rounded to predetermined digits are described in each table shown below.

TABLE 1
Example 1

| Sn | R | D | Nd | vd |
|---|---|---|---|---|
| 1 | 129.8189 | 6.0506 | 1.48749 | 70.24 |
| 2 | −1477.5323 | 0.5002 | | |
| 3 | 79.8627 | 7.6001 | 1.43875 | 94.66 |
| 4 | 1193.6910 | 0.3002 | | |
| 5 | 59.1651 | 8.7202 | 1.49700 | 81.54 |
| 6 | −830.5807 | 2.3000 | 1.85896 | 22.73 |
| 7 | 115.4236 | 0.8454 | | |
| 8 | 105.8711 | 4.0418 | 1.94595 | 17.98 |
| 9 | 297.3988 | 1.8702 | 1.54814 | 45.78 |
| 10 | 46.9736 | 10.0000 | | |
| 11 (St) | ∞ | DD[11] | | |
| 12 | −165.9754 | 3.5664 | 1.85896 | 22.73 |
| 13 | −71.3208 | 1.7200 | 1.63854 | 55.38 |
| 14 | 63.7656 | DD[14] | | |
| 15 | 90.3294 | 5.1513 | 1.59522 | 67.73 |
| 16 | −123.5740 | 1.3124 | | |
| 17 | −346.9798 | 2.8002 | 1.94595 | 17.98 |
| 18 | −97.2740 | 1.5901 | 1.54814 | 45.78 |
| 19 | 79.0076 | 2.0963 | | |
| 20 | 579.8413 | 1.1400 | 1.64769 | 33.79 |
| 21 | 70.9071 | 2.1364 | | |
| 22 | 72.4332 | 7.3536 | 1.75500 | 52.32 |
| 23 | −63.2538 | 1.9001 | 1.95906 | 17.47 |
| 24 | −423.9933 | 12.6171 | | |
| 25 | 99.3547 | 8.1010 | 1.92286 | 18.90 |
| 26 | −154.2282 | 2.6229 | | |
| 27 | −108.6147 | 1.5001 | 1.92119 | 23.96 |
| 28 | 147.8809 | 56.9169 | | |
| 29 | ∞ | 3.2000 | 1.51680 | 64.20 |
| 30 | ∞ | 1.2000 | | |

TABLE 2
Example 1

| | |
|---|---|
| f | 164.91 |
| Bf | 60.23 |
| Fno | 2.88 |
| 2ωm [°] | 18.8 |

TABLE 3
Example 1

| | Infinite Distance | 0.91 m |
|---|---|---|
| DD[11] | 6.0000 | 26.4980 |
| DD[14] | 26.4730 | 5.9750 |

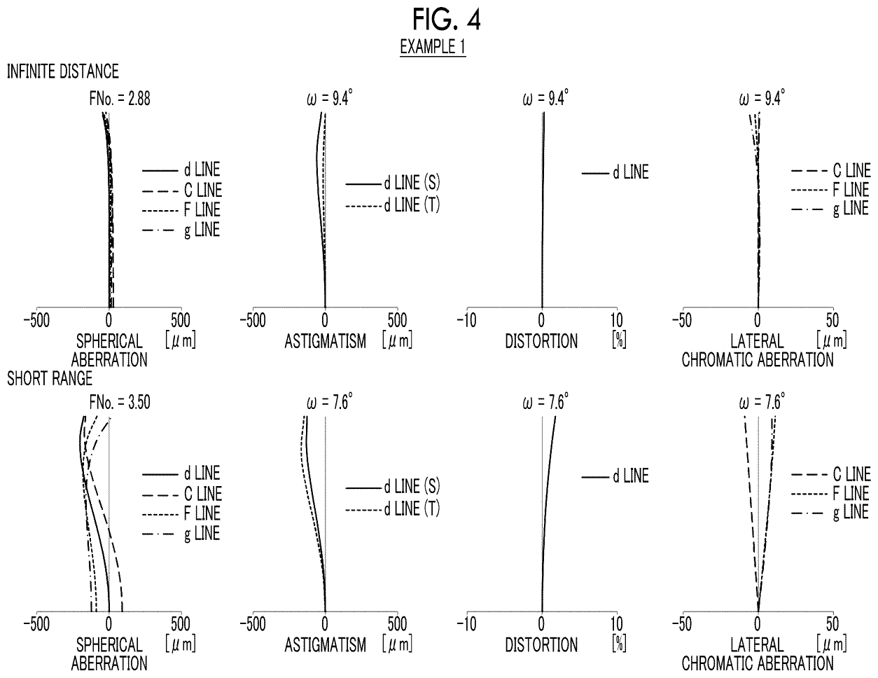

FIG. 4 illustrates each aberration diagram of the imaging lens of Example 1. In FIG. 4, the spherical aberration, the astigmatism, the distortion, and the lateral chromatic aberration are illustrated in this order from the left. In FIG. 4, each aberration diagram in the state where the infinite distance object is in focus is illustrated in an upper part labeled “INFINITE DISTANCE”, and each aberration diagram in the state where the short range object is in focus at the object distance shown in the table of the variable surface spacing is illustrated in a lower part labeled “SHORT RANGE”. In the spherical aberration diagram, aberrations on a d line, a C line, an F line, and a g line are illustrated by a solid line, a long broken line, a short broken line, and a dot-dashed line, respectively. In the astigmatism diagram, an aberration on the d line in a sagittal direction is illustrated by a solid line, and an aberration on the d line in a tangential direction is illustrated by a short broken line. In the distortion diagram, an aberration on the d line is illustrated by a solid line. In the lateral chromatic aberration diagram, aberrations on the C line, the F line, and the g line are illustrated by a long broken line, a short broken line, and a dot-dashed line, respectively. In the spherical aberration diagram, a value of the open F-number is shown after “FNo.=”. In other aberration diagrams, a value of the maximum half angle of view is shown after “ω=”. FNo. and ω in the upper part of the drawing correspond to Fno and ωm, respectively, in the conditional expressions.

Symbols, meanings, description methods, and illustration methods of each data related to Example 1 are basically the same for the following examples unless otherwise specified. Thus, duplicate descriptions will be omitted below.

### Example 2

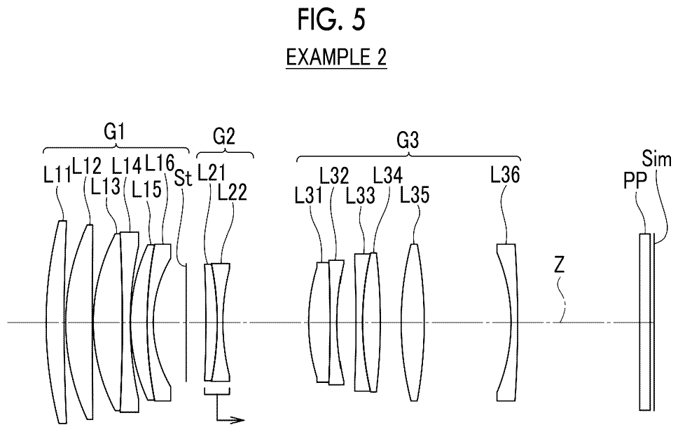

A cross-sectional view of a configuration of an imaging lens of Example 2 is illustrated in FIG. 5. The imaging lens of Example 2 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, six lenses including the lenses L31 to L36. The focus group consists of the second lens group G2, and the second lens group G2 moves to the image side along the optical axis Z during the focusing from the infinite distance object to the short range object.

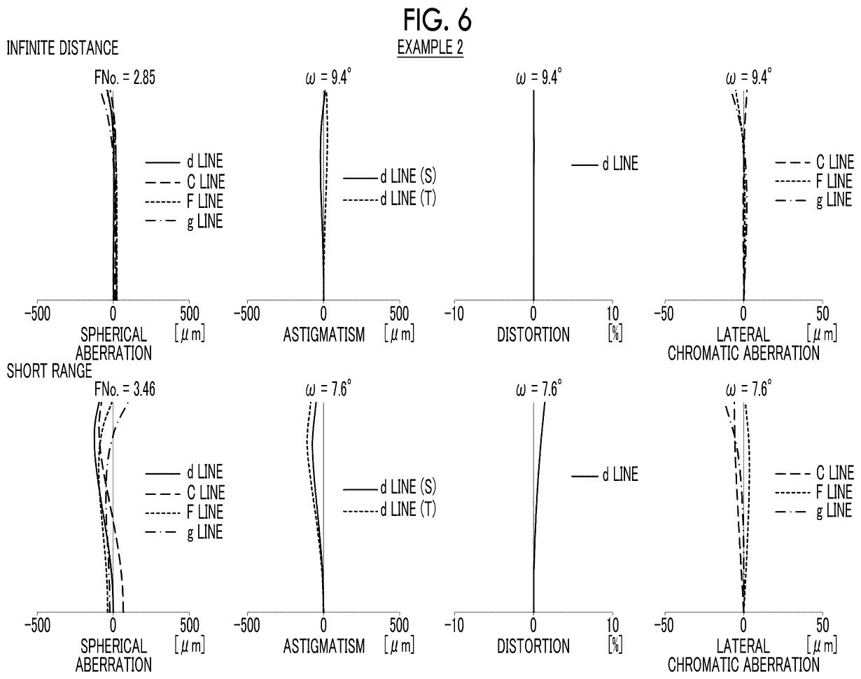

For the imaging lens of Example 2, Table 4 shows basic lens data, Table 5 shows specifications, Table 6 shows a variable surface spacing, and FIG. 6 illustrates each aberration diagram.

TABLE 4
Example 2

| Sn | R | D | Nd | vd |
|---|---|---|---|---|
| 1 | 127.6853 | 5.4502 | 1.58913 | 61.13 |
| 2 | 658.7540 | 0.5002 | | |
| 3 | 72.2919 | 8.0759 | 1.49700 | 81.54 |
| 4 | 4350.3451 | 0.3001 | | |
| 5 | 59.4771 | 8.8045 | 1.49700 | 81.54 |
| 6 | −560.8239 | 2.4000 | 1.76200 | 40.10 |
| 7 | 112.4645 | 0.1000 | | |
| 8 | 57.9800 | 5.0198 | 1.62041 | 60.29 |
| 9 | 128.5499 | 1.8500 | 1.75500 | 52.32 |
| 10 | 40.0004 | 10.0001 | | |
| 11 (St) | ∞ | DD[11] | | |
| 12 | −391.9916 | 3.4097 | 1.95906 | 17.47 |
| 13 | −94.7819 | 1.7201 | 1.83481 | 42.74 |
| 14 | 68.6524 | DD[14] | | |
| 15 | 58.9865 | 6.5201 | 1.49700 | 81.54 |
| 16 | −463.3674 | 2.0000 | 1.80518 | 25.42 |
| 17 | 84.7518 | 5.6859 | | |
| 18 | −456.4689 | 1.9802 | 1.63980 | 34.47 |
| 19 | 95.8705 | 5.3952 | 1.59522 | 67.73 |
| 20 | −191.2024 | 6.3215 | | |
| 21 | 100.1016 | 6.9998 | 1.91082 | 35.25 |
| 22 | −139.8901 | 26.3521 | | |
| 23 | −56.7552 | 2.0001 | 1.65160 | 58.55 |
| 24 | −355.8341 | 37.0256 | | |
| 25 | ∞ | 3.2000 | 1.51680 | 64.20 |
| 26 | ∞ | 1.2000 | | |

TABLE 5
Example 2

| | |
|---|---|
| f | 164.90 |
| Bf | 40.34 |
| Fno | 2.85 |
| 2ωm [°] | 18.8 |

TABLE 6
Example 2

| | Infinite Distance | 0.92 m |
|---|---|---|
| DD[11] | 6.0000 | 25.1347 |
| DD[14] | 26.0269 | 6.8922 |

### Example 3

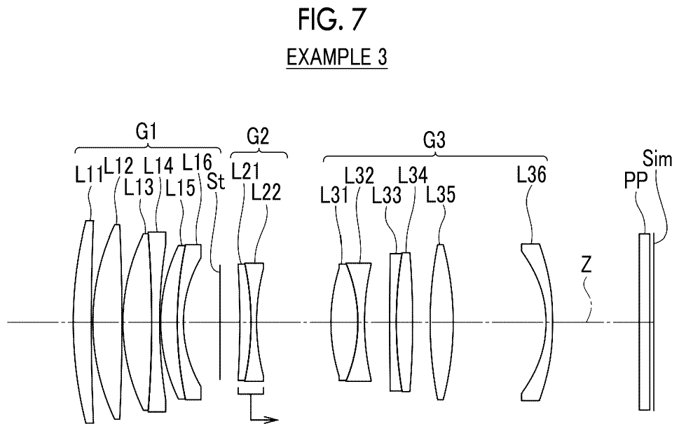

A cross-sectional view of a configuration of an imaging lens of Example 3 is illustrated in FIG. 7. The imaging lens of Example 3 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, six lenses including the lenses L31 to L36. The focus group consists of the second lens group G2, and the second lens group G2 moves to the image side along the optical axis Z during the focusing from the infinite distance object to the short range object.

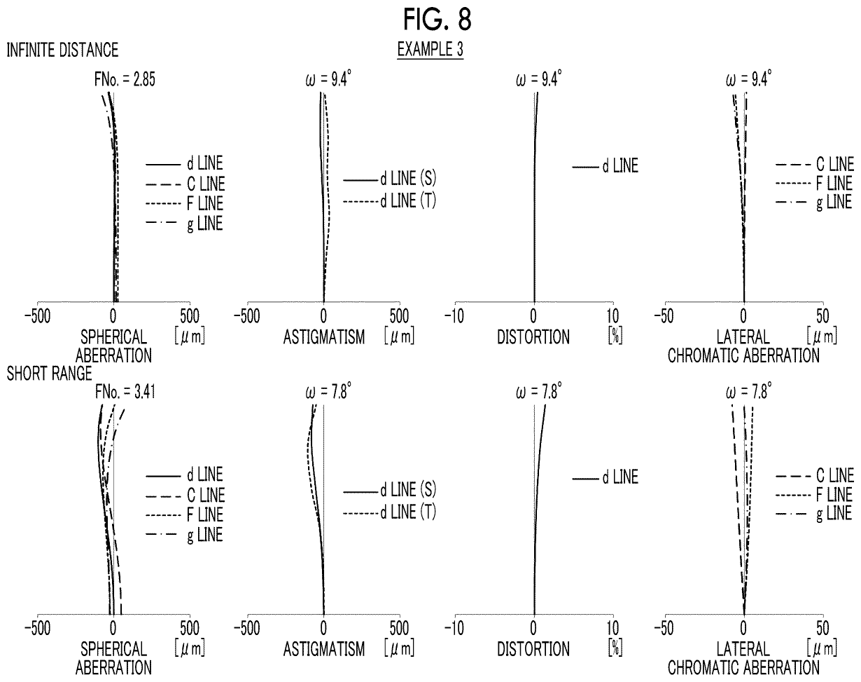

The imaging lens of Example 3 includes an aspherical surface. For the imaging lens of Example 3, Table 7 shows basic lens data, Table 8 shows specifications, Table 9 shows a variable surface spacing, Table 10 shows aspherical coefficients, and FIG. 8 illustrates each aberration diagram.

In the basic lens data, a surface number of the aspherical surface is marked with *, and a field of the curvature radius of the aspherical surface shows a numerical value of a paraxial curvature radius. In Table 10, the column of Sn shows the surface number of the aspherical surface, and columns of KA and Am (m=4, 6, 8, 10, 12, 14, and 16) show numerical values of the aspherical coefficients for each aspherical surface. In the numerical values of the aspherical coefficients in Table 10, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + \sum Am \times {h}^{m}$$

where
Zd: an aspherical depth (a length of a perpendicular line drawn from a point on the aspherical surface at a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients
Σ in the aspheric equation means a sum total related to m.

The above display method related to the aspherical surface is basically the same for the following examples.

TABLE 7
Example 3

| Sn | R | D | Nd | vd |
|---|---|---|---|---|
| 1 | 129.9949 | 5.4500 | 1.58913 | 61.13 |
| 2 | 725.3386 | 0.5002 | | |
| 3 | 71.4656 | 8.8260 | 1.43875 | 94.66 |
| 4 | −661.5744 | 0.3000 | | |
| 5 | 62.8956 | 8.7200 | 1.49700 | 81.54 |
| 6 | −360.4822 | 2.4001 | 1.87070 | 40.73 |
| 7 | 156.2299 | 0.3576 | | |
| 8 | 55.3065 | 5.0200 | 1.62041 | 60.29 |
| 9 | 116.2673 | 1.8502 | 1.75500 | 52.32 |
| 10 | 40.0000 | 11.1182 | | |
| 11 (St) | ∞ | DD[11] | | |
| 12 | −305.2877 | 3.3792 | 1.95906 | 17.47 |
| 13 | −88.6877 | 1.7199 | 1.83481 | 42.74 |
| 14 | 67.3432 | DD[14] | | |
| 15 | 57.0121 | 8.0044 | 1.49700 | 81.54 |
| 16 | −48.0000 | 2.0201 | 1.54072 | 47.23 |
| 17 | 79.8064 | 7.6543 | | |
| 18 | 1589.2334 | 1.9801 | 1.95906 | 17.47 |
| 19 | 131.2448 | 4.9700 | 1.51680 | 64.20 |
| 20 | −275.4057 | 5.3167 | | |
| 21 | 127.5380 | 6.9998 | 1.85025 | 30.05 |
| 22 | −96.3519 | 28.1727 | | |
| *23 | −40.1662 | 2.0000 | 1.69350 | 53.20 |
| *24 | −123.5694 | 26.3032 | | |
| 25 | ∞ | 3.2000 | 1.51680 | 64.20 |
| 26 | ∞ | 1.2000 | | |

TABLE 8
Example 3

| | |
|---|---|
| f | 164.89 |
| Bf | 29.61 |
| Fno | 2.85 |
| 2ωm [°] | 18.8 |

TABLE 9
Example 3

| | Infinite Distance | 0.92 m |
|---|---|---|
| DD[11] | 6.0001 | 22.5637 |
| DD[14] | 22.5506 | 5.9870 |

TABLE 10
Example 3

| Sn | 23 | 24 |
|---|---|---|
| KA | 1.0000000E+00 | 1.0000000E+00 |
| A4 | −1.9656194E−05 | −2.0816466E−05 |
| A6 | 8.3667901E−08 | 8.3397682E−08 |
| A8 | −1.6790149E−10 | −2.0699412E−10 |
| A10 | 4.6955457E−15 | 2.7516550E−13 |
| A12 | 7.5065127E−16 | −8.3729400E−17 |
| A14 | −1.4483497E−18 | −2.0780079E−19 |
| A16 | 9.0212450E−22 | 1.7842506E−22 |

### Example 4

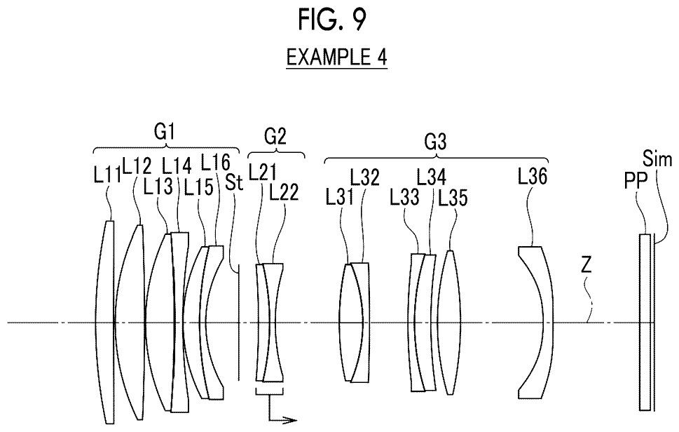

A cross-sectional view of a configuration of an imaging lens of Example 4 is illustrated in FIG. 9. The imaging lens of Example 4 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, six lenses including the lenses L31 to L36. The focus group consists of the second lens group G2, and the second lens group G2 moves to the image side along the optical axis Z during the focusing from the infinite distance object to the short range object.

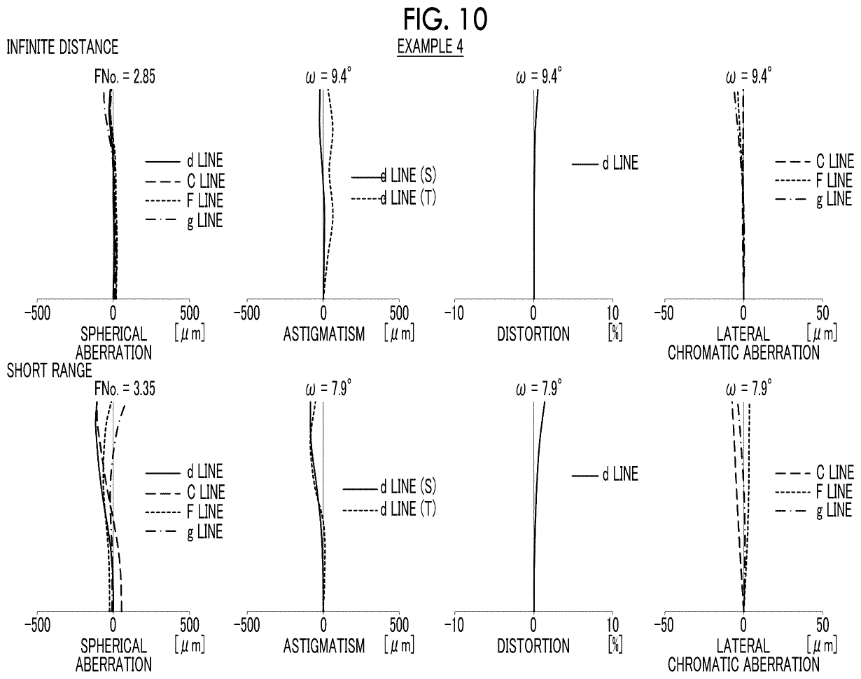

The imaging lens of Example 4 includes an aspherical surface. For the imaging lens of Example 4, Table 11 shows basic lens data, Table 12 shows specifications, Table 13 shows a variable surface spacing, Table 14 shows aspherical coefficients, and FIG. 10 illustrates each aberration diagram.

TABLE 11
Example 4

| Sn | R | D | Nd | vd |
|---|---|---|---|---|
| 1 | 153.3330 | 5.4500 | 1.58913 | 61.13 |
| 2 | 4808.0634 | 0.5000 | | |
| 3 | 69.6679 | 8.9086 | 1.43875 | 94.66 |
| 4 | −742.4948 | 0.3000 | | |
| 5 | 64.6868 | 8.7200 | 1.49700 | 81.54 |
| 6 | −376.8118 | 2.4000 | 1.90043 | 37.37 |
| 7 | 165.6048 | 0.1000 | | |
| 8 | 51.3739 | 5.0198 | 1.62041 | 60.29 |
| 9 | 97.4682 | 1.8502 | 1.75500 | 52.32 |
| 10 | 40.0005 | 10.0000 | | |
| 11 (St) | ∞ | DD[11] | | |
| 12 | −227.7126 | 3.3871 | 1.95906 | 17.47 |
| 13 | −80.7034 | 1.7201 | 1.80400 | 46.53 |
| 14 | 60.2807 | DD[14] | | |
| *15 | 93.1527 | 7.1230 | 1.49710 | 81.56 |
| 16 | −48.0009 | 2.0201 | 1.62004 | 36.26 |
| 17 | −583.1307 | 11.6934 | | |
| 18 | 165.5865 | 1.9801 | 1.95906 | 17.47 |
| 19 | 72.1531 | 4.9700 | 1.54814 | 45.78 |
| 20 | 143.0878 | 2.0000 | | |
| 21 | 81.8151 | 6.9998 | 1.74077 | 27.79 |
| 22 | −106.0995 | 24.9226 | | |
| *23 | −49.0317 | 2.9999 | 1.58313 | 59.46 |
| *24 | −4030885.3624 | 26.3090 | | |
| 25 | ∞ | 3.2000 | 1.51680 | 64.20 |
| 26 | ∞ | 1.2000 | | |

TABLE 12
Example 4

| | |
|---|---|
| f | 164.90 |
| Bf | 29 62 |
| Fno | 2.85 |
| 2ωm [°] | 18.8 |

TABLE 13
Example 4

| | Infinite Distance | 0.93 m |
|---|---|---|
| DD[11] | 6.0000 | 19.4457 |
| DD[14] | 19.4358 | 5.9901 |

TABLE 14
Example 4

| Sn | 15 | 23 | 24 |
|---|---|---|---|
| KA | 1.0000000E+00 | 1.0000000E+00 | 1.0000000E+00 |
| A4 | 1.2604982E−06 | −4.2805427E−05 | −4.2117518E−05 |
| A6 | 3.8625647E−09 | 1.4334349E−07 | 1.5372534E−07 |
| A8 | −6.0708339E−11 | −2.9146450E−10 | −4.1974804E−10 |
| A10 | 5.2781799E−13 | 4.0061254E−14 | 7.7173892E−13 |
| A12 | −2.4369615E−15 | 1.5134418E−15 | −7.9239100E−16 |
| A14 | 5.6598118E−18 | −3.4519578E−18 | 2.9772387E−19 |
| A16 | −5.2024909E−21 | 2.5152122E−21 | 6.2822648E−23 |

### Example 5

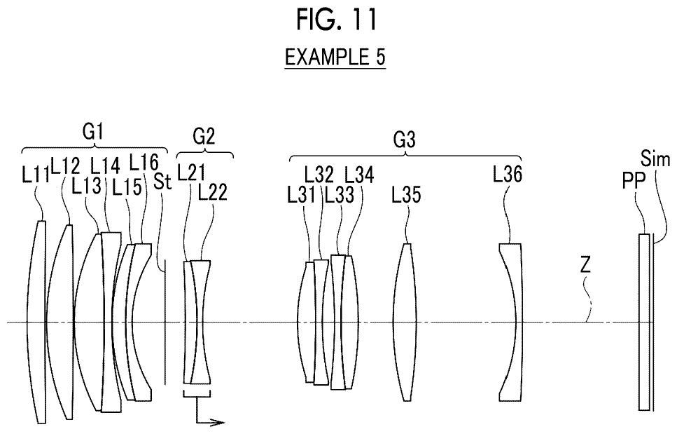

A cross-sectional view of a configuration of an imaging lens of Example 5 is illustrated in FIG. 11. The imaging lens of Example 5 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, six lenses including the lenses L31 to L36. The focus group consists of the second lens group G2, and the second lens group G2 moves to the image side along the optical axis Z during the focusing from the infinite distance object to the short range object.

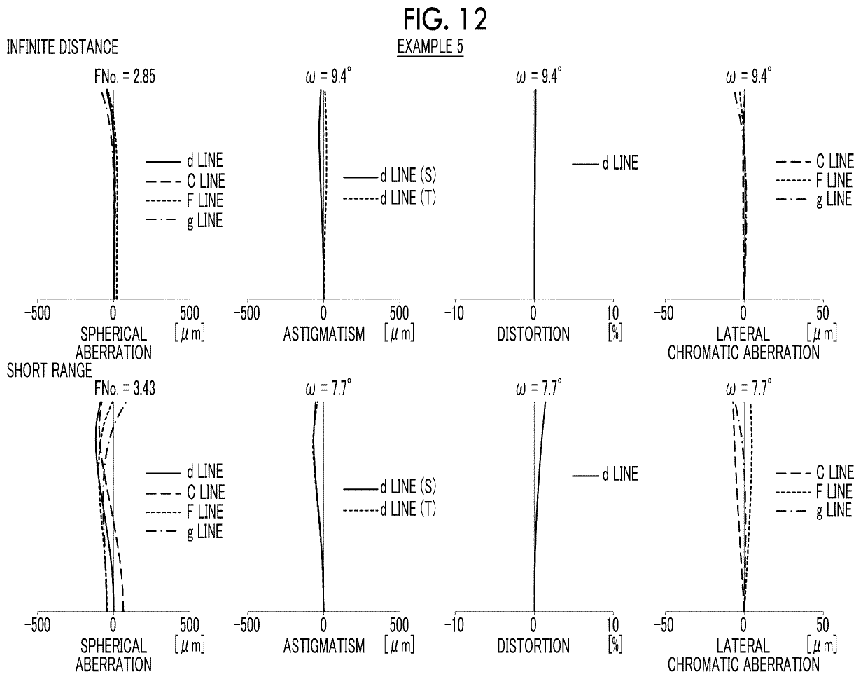

For the imaging lens of Example 5, Table 15 shows basic lens data, Table 16 shows specifications, Table 17 shows a variable surface spacing, and FIG. 12 illustrates each aberration

TABLE 15
Example 5

| Sn | R | D | Nd | vd |
|---|---|---|---|---|
| 1 | 146.8011 | 5.4501 | 1.48749 | 70.24 |
| 2 | 2946.6246 | 0.5002 | | |
| 3 | 76.3437 | 8.0818 | 1.43875 | 94.66 |
| 4 | −1466.7257 | 0.3001 | | |
| 5 | 59.3075 | 9.1132 | 1.49700 | 81.54 |
| 6 | −425.2611 | 2.3000 | 1.70154 | 41.24 |
| 7 | 105.3374 | 0.1002 | | |
| 8 | 63.9808 | 4.1290 | 1.56384 | 60.67 |
| 9 | 101.0377 | 1.9500 | 1.51823 | 58.90 |
| 10 | 40.0003 | 10.0002 | | |
| 11 (St) | 00 | DD[11] | | |
| 12 | −354.1036 | 3.5376 | 1.92286 | 18.90 |
| 13 | −92.3887 | 1.7201 | 1.80400 | 46.53 |
| 14 | 69.8957 | DD[14] | | |
| 15 | 57.5083 | 5.5002 | 1.43875 | 94.66 |
| 16 | −334.6726 | 2.0201 | 1.63980 | 34.47 |
| 17 | 88.8925 | 3.7101 | | |
| 18 | −167.7163 | 1.9802 | 1.68893 | 31.07 |
| 19 | 161.9618 | 5.2609 | 1.59522 | 67.73 |
| 20 | −100.8256 | 10.6008 | | |
| 21 | 91.5065 | 6.9998 | 1.76200 | 40.10 |
| 22 | −158.7665 | 30.1132 | | |
| 23 | −52.5436 | 2.0002 | 1.53996 | 59.46 |
| 24 | −548.8232 | 35.4116 | | |
| 25 | ∞ | 3.2000 | 1.51680 | 64.20 |
| 26 | ∞ | 1.2000 | | |

TABLE 16
Example 5

| | |
|---|---|
| f | 164.89 |
| Bf | 38.72 |
| Fno | 2.85 |
| 2ωm [°] | 18.8 |

TABLE 17
Example 5

| | Infinite Distance | 0.91 m |
|---|---|---|
| DD[11] | 6.0002 | 24.5639 |
| DD[14] | 28.8273 | 10.2636 |

### Example 6

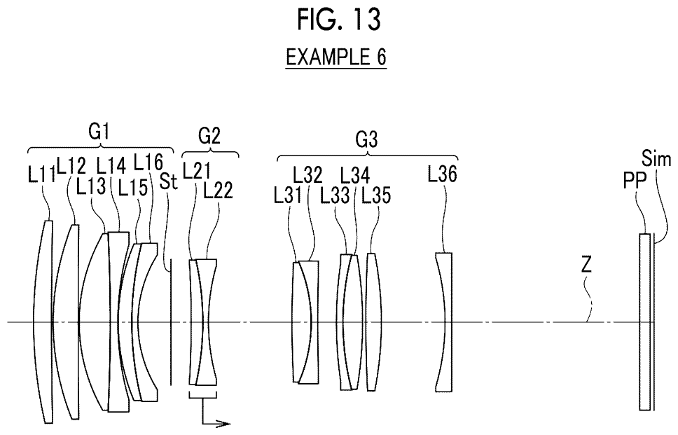

A cross-sectional view of a configuration of an imaging lens of Example 6 is illustrated in FIG. 13. The imaging lens of Example 6 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, six lenses including the lenses L31 to L36. The focus group consists of the second lens group G2, and the second lens group G2 moves to the image side along the optical axis Z during the focusing from the infinite distance object to the short range object.

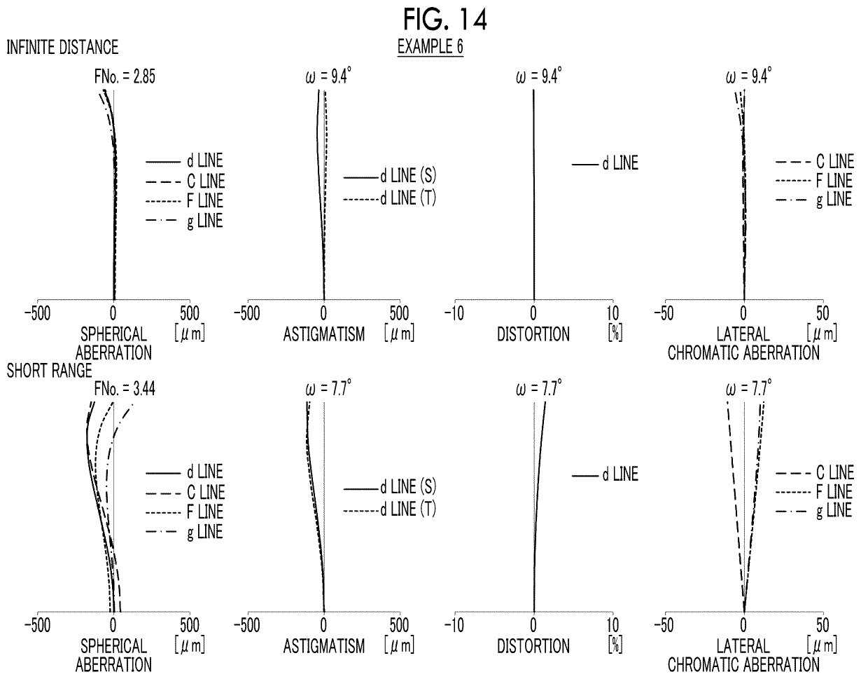

For the imaging lens of Example 6, Table 18 shows basic lens data, Table 19 shows specifications, Table 20 shows a variable surface spacing, and FIG. 14 illustrates each aberration

TABLE 18
Example 6

| Sn | R | D | Nd | vd |
|---|---|---|---|---|
| 1 | 140.9913 | 5.4502 | 1.48749 | 70.24 |
| 2 | 1602.9403 | 0.5002 | | |
| 3 | 81.9711 | 7.6001 | 1.43875 | 94.66 |
| 4 | 3352.6951 | 0.3000 | | |
| 5 | 55.5448 | 9.4419 | 1.49700 | 81.54 |
| 6 | −584.3832 | 2.3002 | 1.67300 | 38.26 |
| 7 | 87.1516 | 0.1002 | | |
| 8 | 63.9596 | 4.1270 | 1.90366 | 31.31 |
| 9 | 100.9846 | 1.8701 | 1.60342 | 38.03 |
| 10 | 40.0000 | 10.0000 | | |
| 11 (St) | ∞ | DD[11] | | |
| 12 | −311.7852 | 3.5220 | 1.89286 | 20.36 |
| 13 | −89.2497 | 1.7202 | 1.74320 | 49.34 |
| 14 | 65.3539 | DD[14] | | |
| 15 | 361.5524 | 5.8187 | 1.43875 | 94.66 |
| 16 | −48.0000 | 2.0202 | 1.63980 | 34.47 |
| 17 | 828.0242 | 5.6441 | | |
| 18 | 130.6925 | 1.9802 | 1.75520 | 27.51 |
| 19 | 84.0836 | 5.9713 | 1.59522 | 67.73 |
| 20 | −126.6476 | 1.0000 | | |
| 21 | 455.8912 | 4.7000 | 1.95375 | 32.32 |
| 22 | −113.1015 | 19.3350 | | |
| 23 | −72.1222 | 2.0002 | 1.64850 | 53.02 |
| 24 | −9582814.8154 | 56.9059 | | |
| 25 | ∞ | 3.2000 | 1.51680 | 64.20 |
| 26 | ∞ | 1.2000 | | |

TABLE 19
Example 6

| | |
|---|---|
| f | 165.42 |
| Bf | 60.22 |
| Fno | 2.85 |
| 2ωm [°] | 18.8 |

TABLE 20
Example 6

| | Infinite Distance | 0.91 m |
|---|---|---|
| DD[11] | 6.0000 | 25.3799 |
| DD[14] | 25.3686 | 5.9887 |

### Example 7

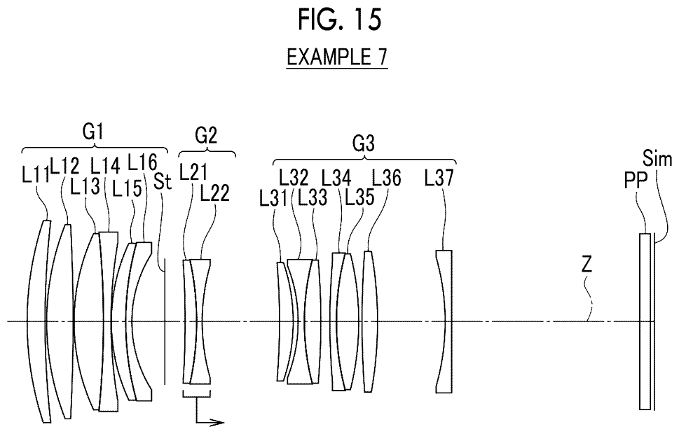

A cross-sectional view of a configuration of an imaging lens of Example 7 is illustrated in FIG. 15. The imaging lens of Example 7 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, seven lenses including the lenses L31 to L37. The focus group consists of the second lens group G2, and the second lens group G2 moves to the image side along the optical axis Z during the focusing from the infinite distance object to the short range object.

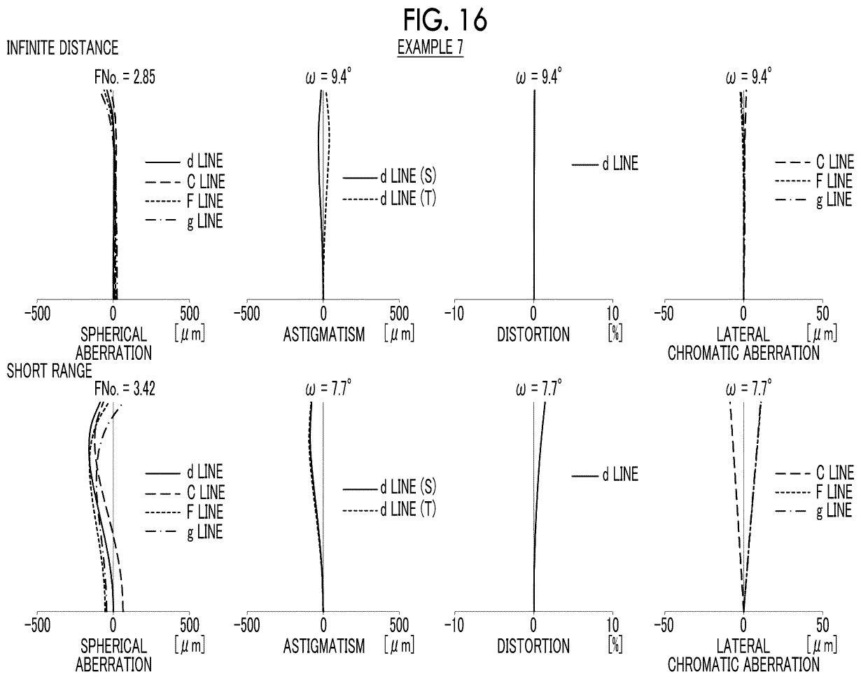

For the imaging lens of Example 7, Table 21 shows basic lens data, Table 22 shows specifications, Table 23 shows a variable surface spacing, and FIG. 16 illustrates each aberration

TABLE 21
Example 7

| Sn | R | D | Nd | vd |
|---|---|---|---|---|
| 1 | 101.7296 | 5.4500 | 1.48749 | 70.24 |
| 2 | 284.3999 | 0.5000 | | |
| 3 | 83.3095 | 8.0073 | 1.43875 | 94.66 |
| 4 | −587.1924 | 0.3000 | | |
| 5 | 65.4956 | 8.9224 | 1.49700 | 81.54 |
| 6 | −278.2028 | 2.3000 | 1.80610 | 40.93 |
| 7 | 146.9143 | 0.1000 | | |
| 8 | 58.1551 | 4.3666 | 1.57099 | 50.80 |
| 9 | 92.3949 | 1.8500 | 1.51742 | 52.43 |
| 10 | 39.9999 | 10.0001 | | |
| 11 (St) | ∞ | DD[11] | | |
| 12 | −281.6744 | 3.4616 | 1.92286 | 18.90 |
| 13 | −91.1250 | 1.7201 | 1.75700 | 47.82 |
| 14 | 64.1084 | DD[14] | | |
| 15 | −220.0752 | 4.1464 | 1.43875 | 94.66 |
| 16 | −57.9360 | 1.5003 | | |
| 17 | −48.0007 | 1.9101 | 1.62004 | 36.26 |
| 18 | 76.9405 | 4.9999 | 1.49700 | 81.54 |
| 19 | −221.0298 | 2.7436 | | |
| 20 | 223.3790 | 2.0001 | 1.58144 | 40.75 |
| 21 | 85.6421 | 6.7532 | 1.71299 | 53.87 |
| 22 | −88.3527 | 1.0002 | | |
| 23 | 300.6899 | 4.7000 | 1.83400 | 37.21 |
| 24 | −126.1576 | 20.5159 | | |
| 25 | −74.3881 | 2.0001 | 1.72916 | 54.68 |
| 26 | ∞ | 56.9073 | | |
| 27 | ∞ | 3.2000 | 1.51680 | 64.20 |
| 28 | ∞ | 1.2000 | | |

TABLE 22
Example 7

| | |
|---|---|
| f | 164.91 |
| Bf | 60.22 |
| Fno | 2.85 |
| 2ωm [°] | 18.8 |

TABLE 23
Example 7

| | Infinite Distance | 0.91 m |
|---|---|---|
| DD[11] | 6.0000 | 23.4701 |
| DD[14] | 23.4523 | 5.9822 |

### Example 8

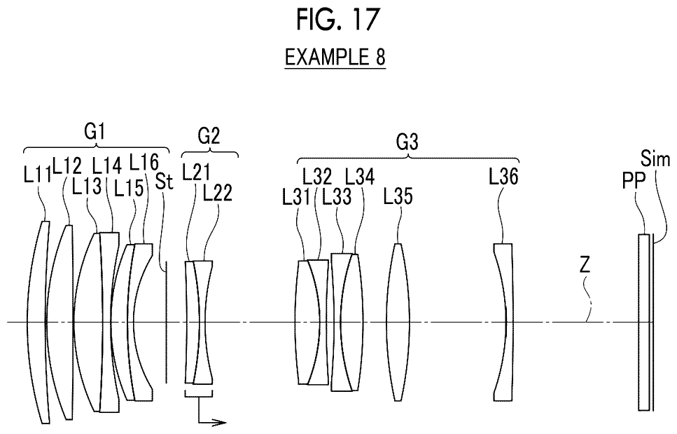

A cross-sectional view of a configuration of an imaging lens of Example 8 is illustrated in FIG. 17. The imaging lens of Example 8 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, six lenses including the lenses L31 to L36. The focus group consists of the second lens group G2, and the second lens group G2 moves to the image side along the optical axis Z during the focusing from the infinite distance object to the short range object.

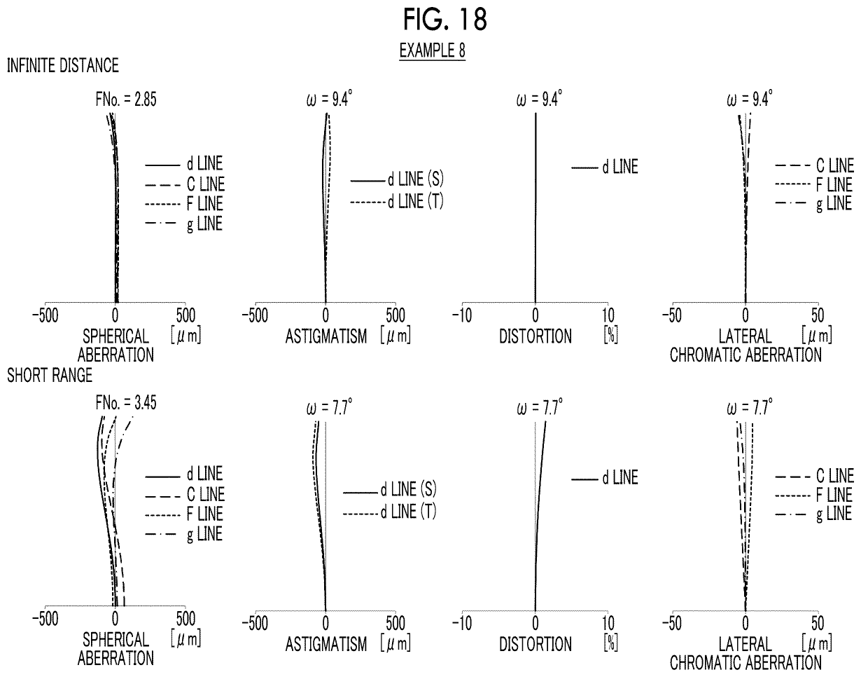

For the imaging lens of Example 8, Table 24 shows basic lens data, Table 25 shows specifications, Table 26 shows a variable surface spacing, and FIG. 18 illustrates each aberration

TABLE 24
Example 8

| Sn | R | D | Nd | vd |
|---|---|---|---|---|
| 1 | 110.3747 | 5.4501 | 1.58913 | 61.13 |
| 2 | 364.1293 | 0.5002 | | |
| 3 | 79.8237 | 7.9616 | 1.49700 | 81.54 |
| 4 | −2229.9329 | 0.3002 | | |
| 5 | 64.7097 | 8.7200 | 1.49700 | 81.54 |
| 6 | −427.4261 | 2.4002 | 1.80440 | 39.59 |
| 7 | 112.5823 | 0.1002 | | |
| 8 | 61.5599 | 5.0000 | 1.62041 | 60.29 |
| 9 | 128.4836 | 1.8702 | 1.57135 | 52.95 |
| 10 | 40.0003 | 10.0000 | | |
| 11 (St) | ∞ | DD[11] | | |
| 12 | −410.1217 | 3.8556 | 1.95906 | 17.47 |
| 13 | −95.8050 | 1.7202 | 1.83481 | 42.74 |
| 14 | 68.9867 | DD[14] | | |
| 15 | 151.3938 | 7.5000 | 1.49700 | 81.54 |
| 16 | −51.6633 | 2.0200 | 1.59551 | 39.24 |
| 17 | 264.4037 | 2.3492 | | |
| 18 | −214.9186 | 2.0001 | 1.67270 | 32.10 |
| 19 | 65.6592 | 6.7924 | 1.69680 | 55.53 |
| 20 | −140.0656 | 7.1267 | | |
| 21 | 114.7572 | 7.0000 | 1.74950 | 35.33 |
| 22 | −115.6949 | 29.3268 | | |
| 23 | −66.5428 | 2.0002 | 1.62041 | 60.29 |
| 24 | −762.5502 | 38.2102 | | |
| 25 | ∞ | 3.2000 | 1.51680 | 64.20 |
| 26 | ∞ | 1.2000 | | |

TABLE 25
Example 8

| | |
|---|---|
| f | 164.91 |
| Bf | 41.52 |
| Fno | 2.85 |
| 2ωm [°] | 18.8 |

TABLE 26
Example 8

| | Infinite Distance | 0.91 m |
|---|---|---|
| DD[11] | 6.0002 | 24.9098 |
| DD[14] | 27.3476 | 8.4380 |

### Example 9

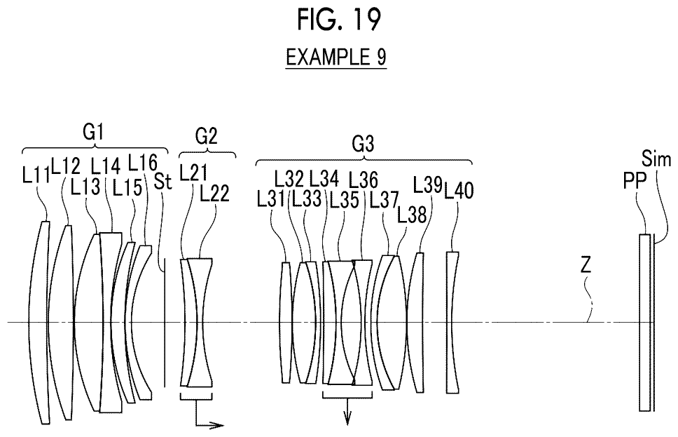

A cross-sectional view of a configuration of an imaging lens of Example 9 is illustrated in FIG. 19. The imaging lens of Example 9 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, 10 lenses including lenses L31 to L40. The focus group consists of the second lens group G2, and the second lens group G2 moves to the image side along the optical axis Z during the focusing from the infinite distance object to the short range object. The vibration-proof group consists of the lenses L34 to L36.

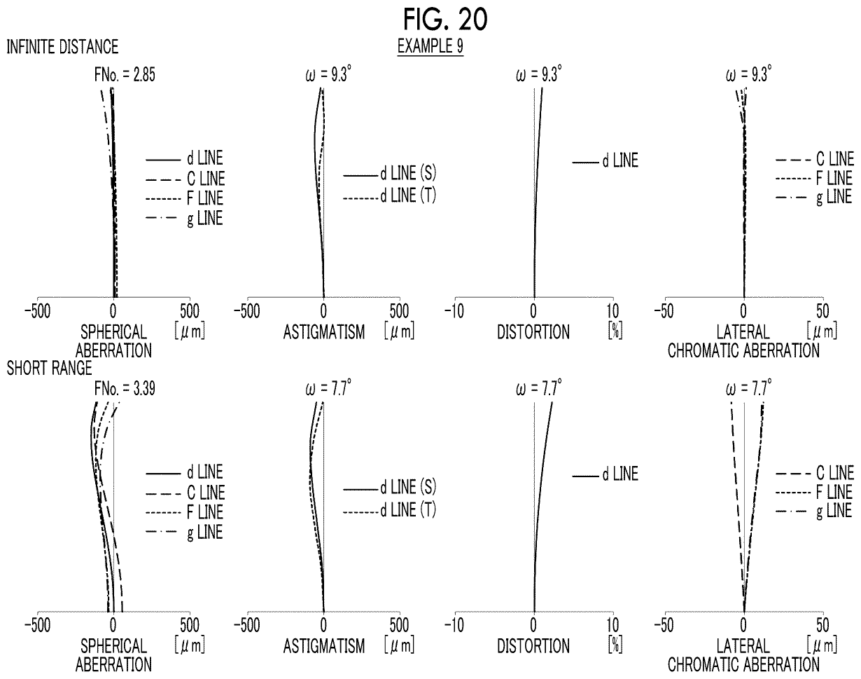

For the imaging lens of Example 9, Table 27 shows basic lens data, Table 28 shows specifications, Table 29 shows a variable surface spacing, and FIG. 20 illustrates each aberration

TABLE 27
Example 9

| Sn | R | D | Nd | vd |
|---|---|---|---|---|
| 1 | 123.3727 | 5.4500 | 1.51823 | 58.90 |
| 2 | 558.0901 | 0.5002 | | |
| 3 | 87.7096 | 7.6000 | 1.43875 | 94.66 |
| 4 | −725.6919 | 0.3002 | | |
| 5 | 64.9620 | 8.7202 | 1.43875 | 94.66 |
| 6 | −369.1291 | 2.3002 | 1.71736 | 29.52 |
| 7 | 89.4435 | 0.1002 | | |
| 8 | 62.2955 | 4.2015 | 1.85896 | 22.73 |
| 9 | 99.4625 | 0.1001 | | |
| 10 | 64.7154 | 1.9000 | 1.59270 | 35.31 |
| 11 | 40.8558 | 10.1002 | | |
| 12 (St) | ∞ | DD[12] | | |
| 13 | −139.4105 | 3.6576 | 1.89286 | 20.36 |
| 14 | −65.9119 | 1.7202 | 1.61772 | 49.81 |
| 15 | 59.0626 | DD[15] | | |
| 16 | 171.8928 | 3.7981 | 1.49700 | 81.54 |
| 17 | −224.0313 | 0.1000 | | |
| 18 | 71.8777 | 7.0651 | 1.59522 | 67.73 |
| 19 | −59.5143 | 1.5000 | 1.95906 | 17.47 |
| 20 | −121.6872 | 0.9575 | | |
| 21 | −745.2799 | 3.7376 | 1.95906 | 17.47 |
| 22 | −75.4212 | 1.5902 | 1.51742 | 52.43 |
| 23 | 40.1534 | 6.0387 | | |
| 24 | −68.8269 | 1.1402 | 1.63980 | 34.47 |
| 25 | 75.9397 | 1.8000 | | |
| 26 | 62.5277 | 1.9002 | 1.95000 | 29.37 |
| 27 | 42.7511 | 8.9496 | 1.61340 | 44.27 |
| 28 | −89.1401 | 0.1000 | | |
| 29 | 77.3355 | 4.7850 | 1.77250 | 49.60 |
| 30 | 981.1788 | 7.3418 | | |
| 31 | −10525.1106 | 1.5001 | 1.57099 | 50.80 |
| 32 | 103.8454 | 56.8910 | | |
| 33 | ∞ | 3.2000 | 1.51680 | 64.20 |
| 34 | ∞ | 1.2000 | | |

TABLE 28
Example 9

| | |
|---|---|
| f | 164.88 |
| Bf | 60.20 |
| Fno | 2.85 |
| 2ωm [°] | 18.6 |

TABLE 29
Example 9

| | Infinite Distance | 0.91 m |
|---|---|---|
| DD[12] | 6.0002 | 23.3524 |
| DD[15] | 23.3367 | 5.9845 |

### Example 10

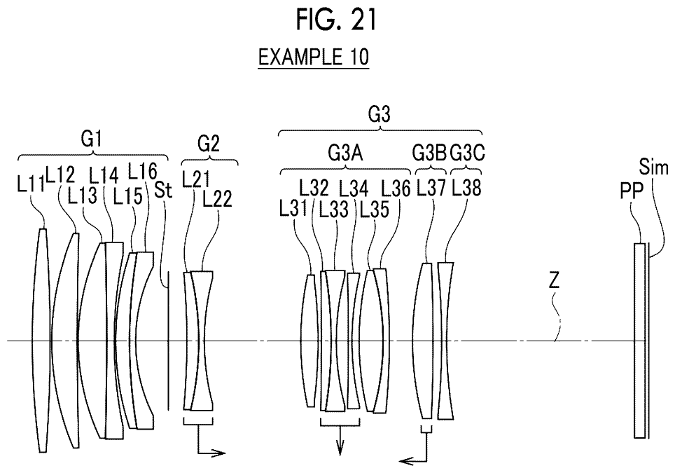

A cross-sectional view of a configuration of an imaging lens of Example 10 is illustrated in FIG. 21. The imaging lens of Example 10 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, a third A lens group G3A, a third B lens group G3B, and a third C lens group G3C. The third A lens group G3A consists of, in order from the object side to the image side, six lenses including the lenses L31 to L36. The third B lens group G3B consists of one lens that is the lens L37. The third C lens group G3C consists of one lens that is the L38. The imaging lens of Example 10 includes two focus groups including the second lens group G2 and the third B lens group G3B. During the focusing from the infinite distance object to the short range object, the second lens group G2 moves to the image side along the optical axis Z, and the third B lens group G3B moves to the object side along the optical axis Z. The vibration-proof group consists of the lenses L32 to L34.

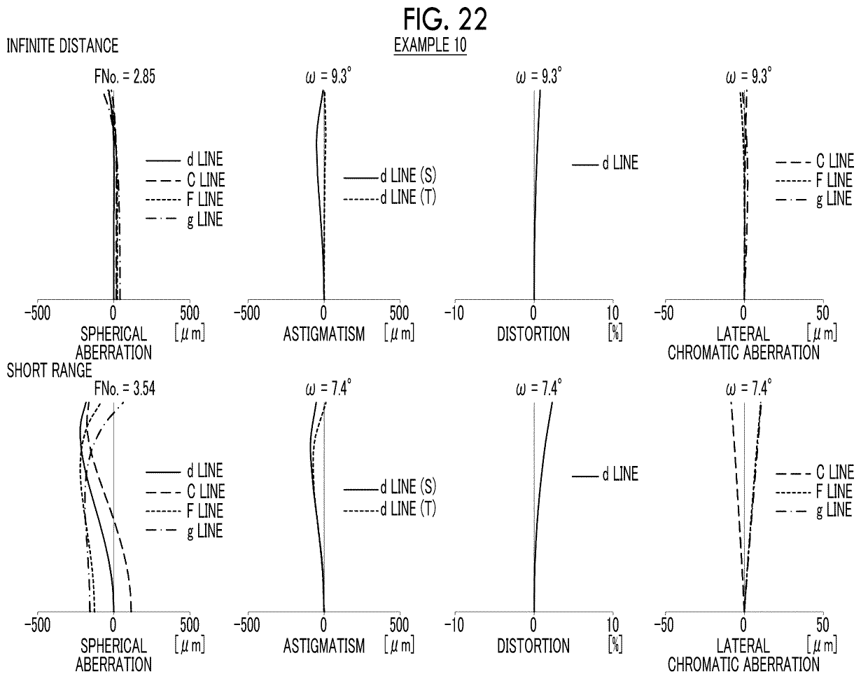

For the imaging lens of Example 10, Table 30 shows basic lens data, Table 31 shows specifications, Table 32 shows a variable surface spacing, and FIG. 22 illustrates each aberration

TABLE 30
Example 10

| Sn | R | D | Nd | νd |
|---|---|---|---|---|
| 1 | 215.0684 | 5.4688 | 1.48749 | 70.24 |
| 2 | −386.0733 | 0.5002 | | |
| 3 | 71.2437 | 7.7979 | 1.43875 | 94.66 |
| 4 | 973.5003 | 0.3002 | | |
| 5 | 58.9839 | 8.7202 | 1.49700 | 81.54 |
| 6 | −1017.7621 | 2.3001 | 1.85000 | 27.03 |
| 7 | 109.0812 | 0.4691 | | |
| 8 | 72.7470 | 4.2134 | 2.00069 | 25.46 |
| 9 | 134.1114 | 1.8702 | 1.65412 | 39.68 |
| 10 | 43.2709 | 10.0001 | | |
| 11 (St) | ∞ | DD[11] | | |
| 12 | −196.3340 | 3.6334 | 1.89286 | 20.36 |
| 13 | −76.3792 | 1.7201 | 1.66672 | 48.32 |
| 14 | 62.8841 | DD[14] | | |
| 15 | 82.4662 | 5.2837 | 1.53775 | 74.70 |
| 16 | −126.2108 | 1.0341 | | |
| 17 | −980.5141 | 2.9648 | 1.95906 | 17.47 |
| 18 | −111.2139 | 1.5900 | 1.54814 | 45.78 |
| 19 | 64.5743 | 3.6800 | | |
| 20 | −774.5144 | 1.1401 | 1.57501 | 41.50 |
| 21 | 73.7329 | 2.1667 | | |
| 22 | 78.1335 | 7.3548 | 1.75500 | 52.32 |
| 23 | −67.2138 | 1.9002 | 1.94595 | 17.98 |
| 24 | −187.8352 | DD[24] | | |
| 25 | 78.4819 | 6.2726 | 1.85478 | 24.80 |
| 26 | −498.5457 | DD[26] | | |
| 27 | −188.4038 | 1.5001 | 2.00069 | 25.46 |
| 28 | 117.9352 | 57.3300 | | |
| 29 | ∞ | 3.2000 | 1.51680 | 64.20 |
| 30 | ∞ | 1.2000 | | |

TABLE 31
Example 10

| | |
|---|---|
| f | 164.90 |
| Bf | 60.64 |
| Fno | 2.85 |
| 2ωm [°] | 18.6 |

TABLE 32
Example 10

| | Infinite Distance | 0.61 m |
|---|---|---|
| DD[11] | 5.5002 | 30.7547 |
| DD[14] | 29.5252 | 4.2707 |
| DD[24] | 7.1063 | 3.8589 |
| DD[26] | 2.6572 | 5.9046 |

### Example 11

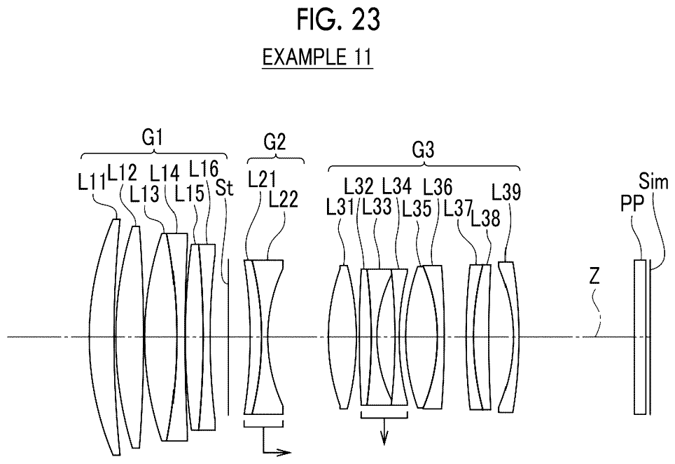

A cross-sectional view of a configuration of an imaging lens of Example 11 is illustrated in FIG. 23. The imaging lens of Example 11 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, nine lenses including the lenses L31 to L39. The focus group consists of the second lens group G2, and the second lens group G2 moves to the image side along the optical axis Z during the focusing from the infinite distance object to the short range object. The vibration-proof group consists of the lenses L32 to L34.

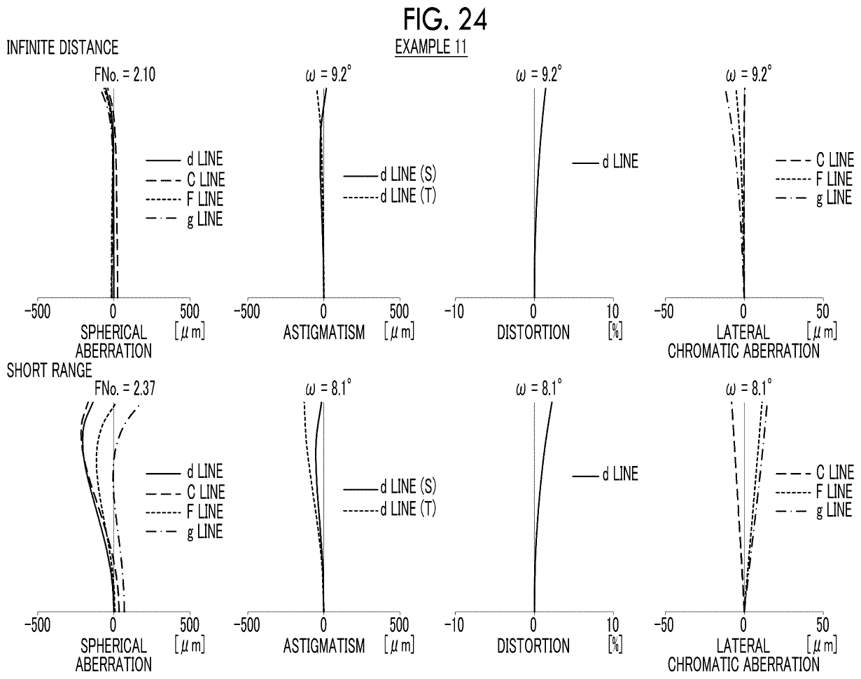

For the imaging lens of Example 11, Table 33 shows basic lens data, Table 34 shows specifications, Table 35 shows a variable surface spacing, and FIG. 24 illustrates each aberration

TABLE 33
Example 11

| Sn | R | D | Nd | νd |
|---|---|---|---|---|
| 1 | 86.4247 | 6.8050 | 1.75500 | 52.32 |
| 2 | 328.2226 | 0.5000 | | |
| 3 | 107.2795 | 7.6333 | 1.43875 | 94.66 |
| 4 | −420.8325 | 0.3000 | | |
| 5 | 91.6324 | 8.7218 | 1.49700 | 81.54 |
| 6 | −156.3775 | 2.2001 | 1.91650 | 31.60 |
| 7 | 538.2859 | 0.1002 | | |
| 8 | 203.6584 | 4.9036 | 1.49700 | 81.54 |
| 9 | −271.4200 | 1.9001 | 1.80440 | 39.58 |
| 10 | 199.3828 | 5.0002 | | |
| 11 (St) | ∞ | DD[11] | | |
| 12 | −141.8728 | 3.1273 | 1.95906 | 17.47 |
| 13 | −89.3601 | 1.7201 | 1.58313 | 59.37 |
| 14 | 46.0430 | DD[14] | | |
| 15 | 58.2890 | 7.7004 | 1.49700 | 81.54 |
| 16 | −81.2809 | 0.8000 | | |
| 17 | 325.8343 | 3.2642 | 1.95906 | 17.47 |
| 18 | −153.7879 | 1.5902 | 1.60342 | 38.03 |
| 19 | 40.0481 | 4.9581 | | |
| 20 | −172.0518 | 1.1426 | 1.51742 | 52.43 |
| 21 | 73.8063 | 1.8002 | | |
| 22 | 60.6538 | 8.7185 | 1.81600 | 46.62 |
| 23 | −52.0486 | 1.9000 | 1.89286 | 20.36 |
| 24 | −264.6767 | 6.0016 | | |
| 25 | 187.5874 | 2.0351 | 1.60342 | 38.03 |
| 26 | 80.9837 | 4.1896 | 1.95375 | 32.32 |
| 27 | 368.4127 | 6.6269 | | |
| 28 | −50.6880 | 1.5000 | 1.51680 | 64.20 |
| 29 | −132.5124 | 31.7219 | | |
| 30 | ∞ | 3.2000 | 1.51680 | 64.20 |
| 31 | ∞ | 1.2000 | | |

TABLE 34
Example 11

| | |
|---|---|
| f | 130.97 |
| Bf | 35.03 |
| Fno | 2.10 |
| 2ωm [°] | 18.4 |

TABLE 35
Example 11

| | Infinite Distance | 0.95 m |
|---|---|---|
| DD[11] | 6.0000 | 16.1724 |
| DD[14] | 16.6640 | 6.4916 |

### Example 12

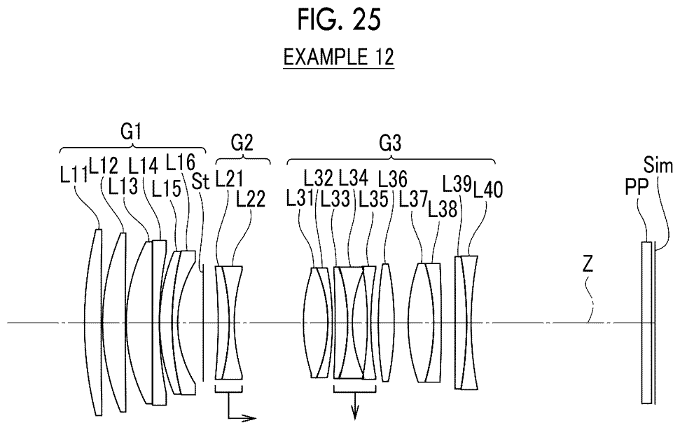

A cross-sectional view of a configuration of an imaging lens of Example 12 is illustrated in FIG. 25. The imaging lens of Example 12 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, 10 lenses including the lenses L31 to L40. The focus group consists of the second lens group G2, and the second lens group G2 moves to the image side along the optical axis Z during the focusing from the infinite distance object to the short range object. The vibration-proof group consists of the lenses L33 to L35.

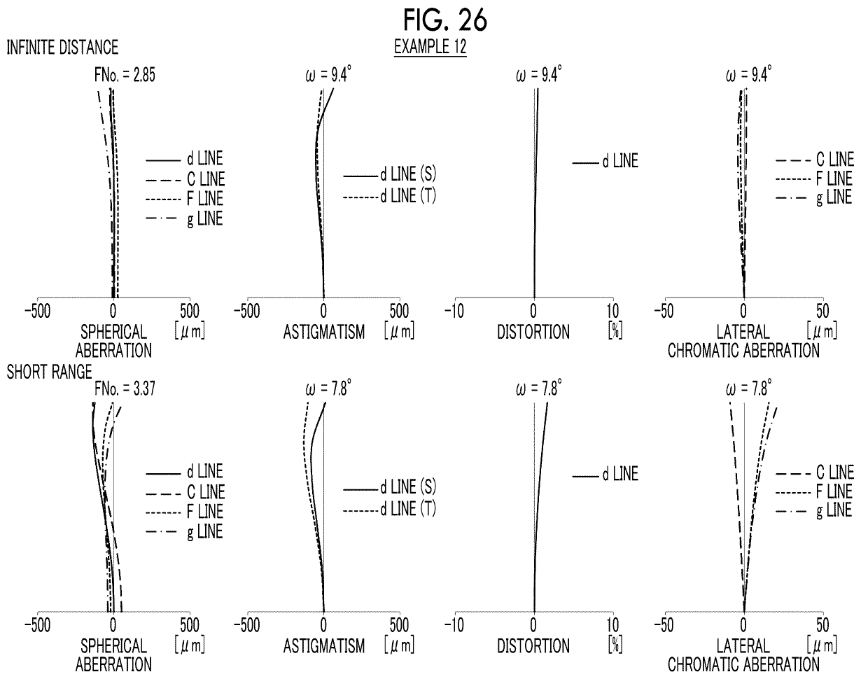

For the imaging lens of Example 12, Table 36 shows basic lens data, Table 37 shows specifications, Table 38 shows a variable surface spacing, and FIG. 26 illustrates each aberration

TABLE 36
Example 12

| Sn | R | D | Nd | νd |
|---|---|---|---|---|
| 1 | 129.2947 | 5.5389 | 1.51680 | 64.20 |
| 2 | 1897.9880 | 0.5000 | | |
| 3 | 77.7999 | 7.6002 | 1.43875 | 94.66 |
| 4 | 3791.1227 | 0.3002 | | |
| 5 | 59.6638 | 8.7202 | 1.43875 | 94.66 |
| 6 | 7343.1715 | 2.3002 | 1.85478 | 24.80 |
| 7 | 124.6765 | 0.1002 | | |
| 8 | 62.4523 | 4.1328 | 1.96300 | 24.11 |
| 9 | 97.2748 | 1.8700 | 1.59551 | 39.24 |
| 10 | 39.0168 | 8.5000 | | |
| 11 (St) | ∞ | DD[11] | | |
| 12 | −191.0839 | 3.6625 | 1.89286 | 20.36 |
| 13 | −75.5778 | 1.7202 | 1.66672 | 48.32 |
| 14 | 60.7242 | DD[14] | | |
| 15 | 56.7639 | 8.1580 | 1.59522 | 67.73 |
| 16 | −46.8230 | 1.5002 | 1.85478 | 24.80 |
| 17 | −100.1416 | 0.9138 | | |
| 18 | −418.7571 | 3.9860 | 1.94595 | 17.98 |
| 19 | −65.0466 | 1.5900 | 1.60738 | 56.82 |
| 20 | 43.7048 | 4.9998 | | |
| 21 | −109.1170 | 1.1402 | 1.72825 | 28.46 |
| 22 | 103.5589 | 2.4995 | | |
| 23 | 135.3223 | 5.2912 | 1.80400 | 46.53 |
| 24 | −100.0969 | 4.6579 | | |
| 25 | 61.3675 | 8.5457 | 1.70154 | 41.24 |
| 26 | −70.2868 | 2.5000 | 1.95906 | 17.47 |
| 27 | −477.4395 | 4.6264 | | |
| 28 | −7884.6720 | 3.8038 | 1.92286 | 18.90 |
| 29 | −133.3370 | 1.5101 | 1.80400 | 46.53 |
| 30 | 118.1326 | 56.9038 | | |
| 31 | ∞ | 3.2000 | 1.51680 | 64.20 |
| 32 | ∞ | 1.2000 | | |

TABLE 37
Example 12

| | |
|---|---|
| f | 164.92 |
| Bf | 60.22 |
| Fno | 2.85 |
| 2ωm [°] | 18.8 |

TABLE 38
Example 12

| | Infinite Distance | 0.91 m |
|---|---|---|
| DD[11] | 5.0001 | 21.7097 |
| DD[14] | 23.0320 | 6.3224 |

### Example 13

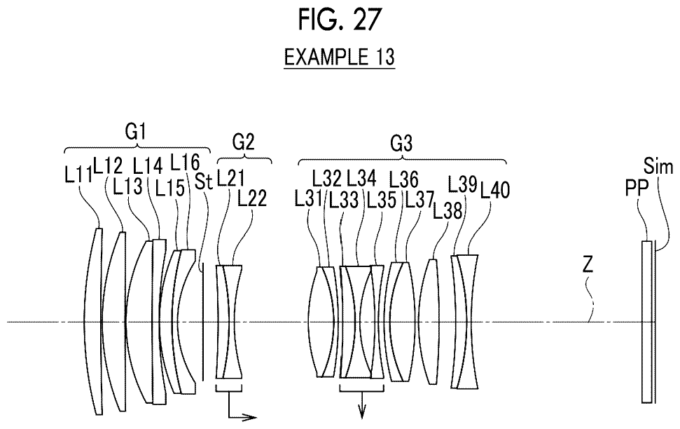

A cross-sectional view of a configuration of an imaging lens of Example 13 is illustrated in FIG. 27. The imaging lens of Example 13 consists of, in order from the object side to the image side, the first lens group G1 having a positive refractive power, the second lens group G2 having a negative refractive power, and the third lens group G3 having a positive refractive power. The first lens group G1 consists of, in order from the object side to the image side, six lenses including the lenses L11 to L16, and the aperture stop St. The second lens group G2 consists of, in order from the object side to the image side, two lenses including the lenses L21 and L22. The third lens group G3 consists of, in order from the object side to the image side, 10 lenses including the lenses L31 to L40. The focus group consists of the second lens group G2, and the second lens group G2 moves to the image side along the optical axis Z during the focusing from the infinite distance object to the short range object. The vibration-proof group consists of the lenses L33 to L35.

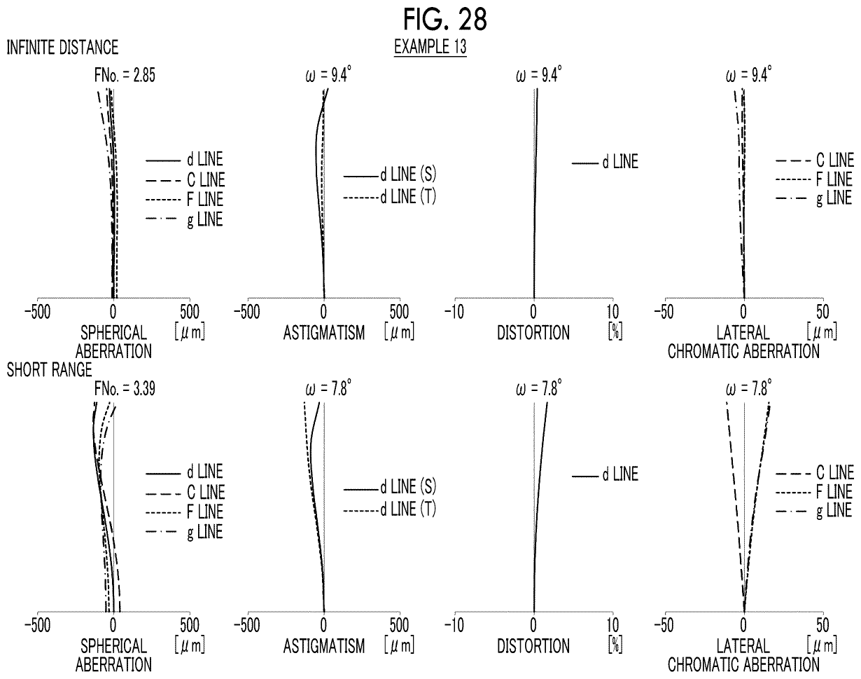

For the imaging lens of Example 13, Table 39 shows basic lens data, Table 40 shows specifications, Table 41 shows a variable surface spacing, and FIG. 28 illustrates each aberration

TABLE 39
Example 13

| Sn | R | D | Nd | νd |
|---|---|---|---|---|
| 1 | 123.7686 | 5.5079 | 1.48749 | 70.24 |
| 2 | 999.2701 | 0.5001 | | |
| 3 | 79.3257 | 7.6001 | 1.43875 | 94.66 |
| 4 | 3195.7015 | 0.3002 | | |
| 5 | 58.3650 | 8.7202 | 1.43875 | 94.66 |
| 6 | 1586.7369 | 2.3000 | 1.90110 | 27.06 |
| 7 | 130.3568 | 0.1000 | | |
| 8 | 61.5185 | 4.1711 | 1.96300 | 24.11 |
| 9 | 95.0227 | 1.8702 | 1.62004 | 36.26 |
| 10 | 38.6502 | 8.5000 | | |
| 11 (St) | ∞ | DD[11] | | |
| 12 | −286.4634 | 3.6742 | 1.84666 | 23.78 |
| 13 | −87.0088 | 1.7200 | 1.69680 | 55.53 |
| 14 | 64.6758 | DD[14] | | |
| 15 | 52.5424 | 8.4727 | 1.59522 | 67.73 |
| 16 | −45.7791 | 1.5001 | 1.85478 | 24.80 |
| 17 | −108.6095 | 1.3234 | | |
| 18 | −228.8507 | 4.0971 | 1.92286 | 18.90 |
| 19 | −56.3444 | 1.5902 | 1.56883 | 56.36 |
| 20 | 42.3150 | 4.9998 | | |
| 21 | −120.4368 | 1.1735 | 1.71736 | 29.52 |
| 22 | 95.8815 | 1.8828 | | |
| 23 | 81.1532 | 1.9000 | 1.96300 | 24.11 |
| 24 | 46.9716 | 8.4240 | 1.65844 | 50.88 |
| 25 | −94.0895 | 1.1667 | | |
| 26 | 62.4457 | 6.8436 | 1.85150 | 40.78 |
| 27 | −241.3993 | 5.5211 | | |
| 28 | −162.7134 | 3.6711 | 1.58144 | 40.75 |
| 29 | −78.5919 | 1.5000 | 1.80400 | 46.53 |
| 30 | 115.2638 | 56.9038 | | |
| 31 | ∞ | 3.2000 | 1.51680 | 64.20 |
| 32 | ∞ | 1.2000 | | |

TABLE 40
Example 13

| | |
|---|---|
| f | 164.90 |
| Bf | 60.21 |
| Fno | 2.85 |
| 2ωm [°] | 18.8 |

TABLE 41
Example 13

| | Infinite Distance | 0.91 m |
|---|---|---|
| DD[11] | 5.0002 | 23.3365 |
| DD[14] | 24.6707 | 6.3344 |

Tables 42 to 44 show the corresponding values of Conditional Expressions (1) to (25) of the imaging lenses of Examples 1 to 13. Preferable ranges of the conditional expressions may be set using the corresponding values of the examples shown in Tables 42 to 44 as the upper limits and the lower limits of the conditional expressions.

TABLE 42

| Expression | | | | | | |
|---|---|---|---|---|---|---|
| Number | | Example 1 | Example 2 | Example 3 | Example 4 | Example 5 |
| (1) | DG1/DA | 0.247 | 0.227 | 0.230 | 0.240 | 0.213 |
| (2) | (tan ωm)/Fno | 0.058 | 0.058 | 0.058 | 0.058 | 0.058 |
| (3) | ν1pave | 66.11 | 71.13 | 74.41 | 74.41 | 76.78 |
| (4) | (RG1r − RG2f)/f | 1.291 | 2.620 | 2.094 | 1.624 | 2.390 |
| (5) | Bf/(f × tan ωm) | 2.208 | 1.475 | 1.087 | 1.088 | 1.418 |
| (6) | f/fLe1 | −2.433 | −1.587 | −1.903 | −1.961 | −1.530 |
| (7) | \|(1 − β2²) × β3²\| | 1.729 | 1.841 | 2.075 | 2.491 | 1.890 |
| (8) | DG1/TL | 0.169 | 0.177 | 0.191 | 0.198 | 0.169 |
| (9) | H1r/H1f | 0.720 | 0.673 | 0.667 | 0.667 | 0.701 |
| (10) | Den/f | 0.286 | 0.307 | 0.334 | 0.314 | 0.292 |
| (11) | f/f1 | 1.319 | 1.365 | 1.456 | 1.594 | 1.382 |
| (12) | f/f2 | −2.010 | −2.202 | −2.344 | −2.595 | −2.125 |
| (13) | f/f3 | 1.522 | 1.593 | 1.501 | 1.459 | 1.509 |
| (14) | DG2/TL | 0.028 | 0.028 | 0.029 | 0.030 | 0.028 |
| (15) | f1/f23 | −0.015 | −0.133 | −0.519 | −0.771 | −0.196 |
| (16) | DG3/TL | 0.264 | 0.345 | 0.384 | 0.385 | 0.361 |
| (17) | f2/f1 | −0.656 | −0.620 | −0.621 | −0.614 | −0.651 |
| (18) | (RLe1f + RLe2r)/(RLe1f − RLe2r) | −5.762 | −2.365 | −2.430 | −2.718 | −1.989 |
| (19) | (RG2f + RG2r)/(RG2f − RG2r) | 0.445 | 0.702 | 0.639 | 0.581 | 0.670 |
| (20) | TL × Fno/f | 3.293 | 3.167 | 3.023 | 2.906 | 3.265 |
| (21) | f2/f3 | −0.757 | −0.724 | −0.641 | −0.562 | −0.710 |
| (22) | fLe2/fLe1 | −0.981 | −0.625 | −0.756 | −0.754 | −0.716 |
| (23) | f3/fIS | −1.4885 | — | — | — | — |
| (24) | f3/f3F1 | 1.2250 | −0.1330 | 0.1602 | 0.4378 | 0.0132 |
| (25) | ν3p | 67.73 | 81.54 | 81.54 | 81.56 | 94.66 |

TABLE 43

| Expression | | | | | | |
|---|---|---|---|---|---|---|
| Number | | Example 6 | Example 7 | Example 8 | Example 9 | Example 10 |
| (1) | DG1/DA | 0.250 | 0.247 | 0.219 | 0.243 | 0.250 |
| (2) | (tan ωm)/Fno | 0.058 | 0.058 | 0.058 | 0.058 | 0.058 |
| (3) | ν1pave | 69.44 | 74.31 | 71.13 | 67.74 | 67.97 |
| (4) | (RG1r − RG2f)/f | 2.127 | 1.951 | 2.730 | 1.093 | 1.453 |
| (5) | Bf/(f × tan ωm) | 2.200 | 2.204 | 1.519 | 2.223 | 2.234 |
| (6) | f/fLe1 | −1.487 | −1.616 | −1.402 | −0.916 | −2.281 |
| (7) | \|(1 − β2²) × β3²] | 1.826 | 1.995 | 1.866 | 2.002 | 1.877 |
| (8) | DG1/TL | 0.169 | 0.168 | 0.171 | 0.165 | 0.169 |
| (9) | H1r/H1f | 0.708 | 0.708 | 0.688 | 0.721 | 0.711 |
| (10) | Den/f | 0.282 | 0.288 | 0.298 | 0.276 | 0.280 |
| (11) | f/f1 | 1.357 | 1.418 | 1.373 | 1.423 | 1.381 |
| (12) | f/f2 | −2.088 | −2.200 | −2.177 | −2.109 | −2.024 |
| (13) | f/f3 | 1.533 | 1.539 | 1.570 | 1.470 | 1.454 |
| (14) | DG2/TL | 0.028 | 0.027 | 0.030 | 0.029 | 0.029 |
| (15) | f1/f23 | −0.049 | −0.088 | −0.114 | −0.080 | −0.065 |
| (16) | DG3/TL | 0.259 | 0.277 | 0.350 | 0.277 | 0.238 |
| (17) | f2/f1 | −0.650 | −0.645 | −0.631 | −0.675 | −0.683 |
| (18) | (RLe1f + RLe2r)/(RLe1f − RLe2r) | −4.520 | −3.874 | −3.708 | 0.829 | −2.215 |
| (19) | (RG2f + RG2r)/(RG2f − RG2r) | 0.653 | 0.629 | 0.712 | 0.405 | 0.515 |
| (20) | TL × Fno/f | 3.221 | 3.265 | 3.264 | 3.258 | 3.237 |
| (21) | f2/f3 | −0.734 | −0.700 | −0.721 | −0.697 | −0.718 |
| (22) | fLe2/fLe1 | −0.858 | −1.050 | −0.662 | −0.602 | −1.103 |
| (23) | f3/fIS | — | — | — | −3.0218 | −1.6452 |
| (24) | f3/f3F1 | −0.4022 | 0.6024 | −0.0844 | 0.5713 | 1.2122 |
| (25) | ν3p | 94.66 | 94.66 | 81.54 | 81.54 | 74.70 |

TABLE 44

| Expression | | Exam- | Exam- | Exam- |
|---|---|---|---|---|
| Number | | ple 11 | ple 12 | ple 13 |
| (1) | DG1/DA | 0.281 | 0.241 | 0.241 |
| (2) | (tan ωm)/Fno | 0.078 | 0.058 | 0.058 |
| (3) | ν1pave | 77.52 | 69.41 | 70.92 |
| (4) | (RG1r − RG2f)/f | 2.606 | 1.395 | 1.972 |
| (5) | Bf/(f × tan ωm) | 1.642 | 2.211 | 2.210 |
| (6) | f/fLe1 | −0.819 | −0.994 | −2.226 |
| (7) | \|(1 − β2²) × β3²\| | 1.988 | 2.080 | 1.910 |
| (8) | DG1/TL | 0.216 | 0.164 | 0.164 |
| (9) | H1r/H1f | 0.740 | 0.704 | 0.708 |
| (10) | Den/f | 0.295 | 0.259 | 0.257 |
| (11) | f/f1 | 1.431 | 1.454 | 1.393 |
| (12) | f/f2 | −2.009 | −2.103 | −1.991 |
| (13) | f/f3 | 1.344 | 1.425 | 1.406 |
| (14) | DG2/TL | 0.032 | 0.028 | 0.029 |
| (15) | f1/f23 | −0.240 | −0.112 | −0.127 |
| (16) | DG3/TL | 0.342 | 0.295 | 0.286 |
| (17) | f2/f1 | −0.712 | −0.692 | −0.700 |
| (18) | (RLe1f + RLe2r)/ | −0.758 | 1.129 | −5.136 |
| | (RLe1f − RLe2r) | | | |
| (19) | (RG2f + RG2r)/ | 0.510 | 0.518 | 0.632 |
| | (RG2f − RG2r) | | | |
| (20) | TL × Fno/f | 2.451 | 3.265 | 3.265 |
| (21) | f2/f3 | −0.669 | −0.678 | −0.706 |
| (22) | fLe2/fLe1 | −1.254 | −0.612 | −0.795 |
| (23) | f3/fIS | −1.9616 | −2.9514 | −3.0007 |
| (24) | f3/f3F1 | 1.4003 | 1.5364 | 1.5665 |
| (25) | ν3p | 81.54 | 67.73 | 67.73 |

The imaging lenses of Examples 1 to 13 have an F-number less than 3 and a large image circle and maintain high optical performance through favorable correction of various aberrations while being configured to be reduced in size.

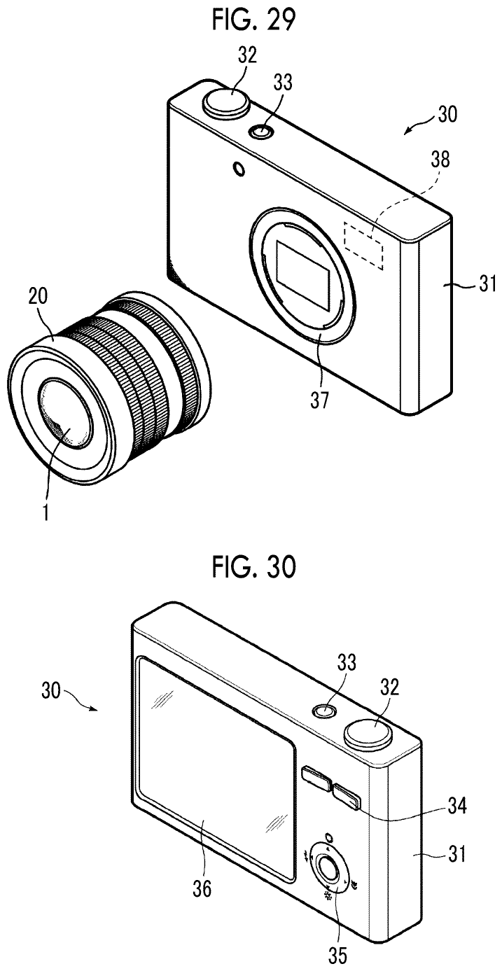

Next, an imaging apparatus according to the embodiment of the present disclosure will be described. FIGS. 29 and 30 illustrate external views of a camera 30 that is the imaging apparatus according to one embodiment of the present disclosure. FIG. 29 illustrates a perspective view of the camera 30 seen from its front surface side, and FIG. 30 illustrates a perspective view of the camera 30 seen from its rear surface side. The camera 30 is a so-called mirrorless type digital camera on which an interchangeable lens 20 can be attachably and detachably mounted. The interchangeable lens 20 is configured to include an imaging lens 1 according to one embodiment of the present disclosure accommodated in a lens barrel.

The camera 30 comprises a camera body 31. A shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before capturing.

An imaging aperture on which light from an imaging target is incident is provided in a center portion of a front surface of the camera body 31. A mount 37 is provided at a position corresponding to the imaging aperture, and the interchangeable lens 20 is mounted on the camera body 31 through the mount 37.

An imaging element 38 is provided in the camera body 31. The imaging element 38 outputs an imaging signal corresponding to a subject image formed by the interchangeable lens 20. For example, a charge coupled device (CCD) or a complementary metal oxide semiconductor (CMOS) is used as the imaging element 38. A signal processing circuit (not illustrated), a recording medium (not illustrated), and the like are provided in the camera body 31. The signal processing circuit generates an image by processing the imaging signal output from the imaging element 38. The generated image is recorded on the recording medium. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples and can be subjected to various modifications. For example, the curvature radius, the surface spacing, the refractive index, the Abbe number, and the aspherical coefficients of each lens are not limited to the values shown in each example and may have other values.

The imaging apparatus according to the embodiment of the present disclosure is also not limited to the above example and can have various aspects of, for example, a camera of a type other than a mirrorless type, a film camera, a video camera, and a security camera.

The following appendices are further disclosed with respect to the embodiment and the examples described above.

### Appendix 1

An imaging lens consisting of, in order from an object side to an image side, a first lens group having a positive refractive power, a second lens group having a negative refractive power, and a third lens group having a positive refractive power, in which, during focusing, at least the second lens group moves along an optical axis, the second lens group is a group closest to the object side among groups that move during the focusing, the first lens group includes, in consecutive order from a position closest to the object side to the image side, two positive lenses, in a case where one lens component is one single lens or one cemented lens, the third lens group includes a lens component having a negative refractive power closest to the image side, and in a case where a distance on the optical axis from a lens surface of the first lens group closest to the object side to a lens surface of the first lens group closest to the image side is denoted by DG1, a distance on the optical axis from the lens surface of the first lens group closest to the object side to a lens surface of the third lens group closest to the image side in a state where an infinite distance object is in focus is denoted by DA, a maximum half angle of view in the state where the infinite distance object is in focus is denoted by ωm, and an open F-number in the state where the infinite distance object is in focus is denoted by Fno, Conditional Expressions (1) and (2) are satisfied, which are represented by

$$14 < DG 1 / DA < 0.5 and \qquad ( 1 )$$

$$0.02 < ( tan ω m ) / Fno < 0 \text{.15} . \qquad ( 2 )$$

### Appendix 2

The imaging lens according to Appendix 1, in which, in a case where an average value of Abbe numbers based on a d line for all positive lenses included in the first lens group is denoted by v1pave, Conditional Expression (3) is satisfied, which is represented by

$$55 < v 1 pave < 95. \qquad ( 3 )$$

### Appendix 3

The imaging lens according to Appendix 1 or 2, in which the first lens group includes, in consecutive order from the position closest to the object side to the image side, the two positive lenses, a positive lens, and a negative lens.

### Appendix 4

The imaging lens according to any one of Appendices 1 to 3, in which an aperture stop is disposed between the lens surface of the first lens group closest to the image side and a lens surface of the second lens group closest to the object side.

### Appendix 5

The imaging lens according to any one of Appendices 1 to 4, in which the first lens group includes, in order from the object side to the image side, only six lenses consisting of the two positive lenses, a positive lens, a negative lens, a positive lens, and a negative lens as lenses.

### Appendix 6

The imaging lens according to any one of Appendices 1 to 5, in which the second lens group includes at least one positive lens and at least one negative lens.

### Appendix 7

The imaging lens according to Appendix 6, in which the second lens group consists of one cemented lens in which a positive lens and a negative lens are cemented.

### Appendix 8

The imaging lens according to any one of Appendices 1 to 7, in which a lens component having a positive refractive power is disposed adjacent to the object side of the lens component having the negative refractive power closest to the image side in the third lens group.

### Appendix 9

The imaging lens according to any one of Appendices 1 to 8, in which an aperture stop is disposed between the lens surface of the first lens group closest to the image side and a lens surface of the second lens group closest to the object side, the lens surface of the first lens group closest to the image side and the lens surface of the second lens group closest to the object side have concave shapes, and in a case where a curvature radius of the lens surface of the first lens group closest to the image side is denoted by RG1r, a curvature radius of the lens surface of the second lens group closest to the object side is denoted by RG2f, and a focal length of the imaging lens in the state where the infinite distance object is in focus is denoted by f, Conditional Expression (4) is satisfied, which is represented by

$$0.7 < ( RG 1 r - RG 2 f ) / f < 4. \qquad ( 4 )$$

### Appendix 10

The imaging lens according to any one of Appendices 1 to 9, in which, in a case where a back focus of the imaging lens as an air conversion distance in the state where the infinite distance object is in focus is denoted by Bf, and a focal length of the imaging lens in the state where the infinite distance object is in focus is denoted by f, Conditional Expression (5) is satisfied, which is represented by

$$0.7 < Bf / ( f \times tan ω m ) < 3. \qquad ( 5 )$$

### Appendix 11

The imaging lens according to any one of Appendices 1 to 10, in which, in a case where a focal length of the imaging lens in the state where the infinite distance object is in focus is denoted by f, and a focal length of the lens component having the negative refractive power closest to the image side in the third lens group is denoted by fLe1, Conditional Expression (6) is satisfied, which is represented by

$$- 32 < f / fLe 1 {<}_{} - 0.6 . \qquad ( 6 )$$

### Appendix 12

The imaging lens according to any one of Appendices 1 to 11, in which, in a case where a lateral magnification of the second lens group in the state where the infinite distance object is in focus is denoted by β2, and a lateral magnification of the third lens group in the state where the infinite distance object is in focus is denoted by β3, Conditional Expression (7) is satisfied, which is represented by

$$1.3 < \vert ( 1 - {β2}^{2} ) \times β {3}^{2} \vert < 3.5 . \qquad ( 7 )$$

### Appendix 13

The imaging lens according to any one of Appendices 1 to 12, in which, in a case where a sum of DA and a back focus of the imaging lens as an air conversion distance in the state where the infinite distance object is in focus is denoted by TL, Conditional Expression (8) is satisfied, which is represented by

$$0.1 < DG 1 / TL < 0.3 . \qquad ( 8 )$$

### Appendix 14

The imaging lens according to any one of Appendices 1 to 13, in which, in a case where a height of an on-axis marginal ray from the optical axis on the lens surface of the first lens group closest to the image side in the state where the infinite distance object is in focus is denoted by H1r, and a height of an on-axis marginal ray from the optical axis on the lens surface of the first lens group closest to the object side in the state where the infinite distance object is in focus is denoted by H1f, Conditional Expression (9) is satisfied, which is represented by

$$0.5 < H 1 r / H1f < 0.85 . \qquad ( 9 )$$

### Appendix 15

The imaging lens according to any one of Appendices 1 to 14, in which, in a case where a distance on the optical axis from the lens surface of the first lens group closest to the object side to a paraxial entrance pupil position in the state where the infinite distance object is in focus is denoted by Den, and a focal length of the imaging lens in the state where the infinite distance object is in focus is denoted by f, Conditional Expression (10) is satisfied, which is represented by

$$0.2 < Den / f < 0.5 . \qquad ( 10 )$$

### Appendix 16

The imaging lens according to any one of Appendices 1 to 15, in which, in a case where a focal length of the imaging lens in the state where the infinite distance object is in focus is denoted by f, and a focal length of the first lens group is denoted by f1, Conditional Expression (11) is satisfied, which is represented by

$$1. 2 < f / f 1 < 2. \qquad ( 11 )$$

### Appendix 17

The imaging lens according to any one of Appendices 1 to 16, in which, in a case where a focal length of the imaging lens in the state where the infinite distance object is in focus is denoted by f, and a focal length of the second lens group is denoted by f2, Conditional Expression (12) is satisfied, which is represented by

$$- 3 < f / f 2 {<}_{} - 1.3 . \qquad ( 12 )$$

### Appendix 18

The imaging lens according to any one of Appendices 1 to 17, in which, in a case where a focal length of the imaging lens in the state where the infinite distance object is in focus is denoted by f, and a focal length of the third lens group is denoted by f3, Conditional Expression (13) is satisfied, which is represented by

$$0.8 < f / f 3 < 2.5 . \qquad ( 13 )$$

### Appendix 19

The imaging lens according to any one of Appendices 1 to 18, in which, in a case where a distance on the optical axis from a lens surface of the second lens group closest to the object side to a lens surface of the second lens group closest to the image side is denoted by DG2, and a sum of DA and a back focus of the imaging lens as an air conversion distance in the state where the infinite distance object is in focus is denoted by TL, Conditional Expression (14) is satisfied, which is represented by

$$0.02 < DG 2 / TL < 0.1 . \qquad ( 14 )$$

### Appendix 20

An imaging apparatus comprising the imaging lens according to any one of Appendices 1 to 19.

What is claimed is:

1. An imaging lens consisting of, in order from an object side to an image side, a first lens group having a positive refractive power, a second lens group having a negative refractive power, and a third lens group having a positive refractive power,
wherein, during focusing, at least the second lens group moves along an optical axis,
the second lens group is a group closest to the object side among groups that move during the focusing,
the first lens group includes, in consecutive order from a position closest to the object side to the image side, two positive lenses,
in a case where one lens component is one single lens or one cemented lens,
the third lens group includes a lens component having a negative refractive power closest to the image side, and
in a case where a distance on the optical axis from a lens surface of the first lens group closest to the object side to a lens surface of the first lens group closest to the image side is denoted by DG1,
a distance on the optical axis from the lens surface of the first lens group closest to the object side to a lens surface of the third lens group closest to the image side in a state where an infinite distance object is in focus is denoted by DA,
a maximum half angle of view in the state where the infinite distance object is in focus is denoted by ωm, and
an open F-number in the state where the infinite distance object is in focus is denoted by Fno,
Conditional Expressions (1) and (2) are satisfied, which are represented by
$$0.14 < DG 1 / DA < 0.5 \qquad ( 1 )$$
$$and$$
$$0.02 < ( tan ω m ) / Fno < 0.15 . \qquad ( 2 )$$

2. The imaging lens according to claim 1,
wherein, in a case where an average value of Abbe numbers based on a d line for all positive lenses included in the first lens group is denoted by v1pave,
Conditional Expression (3) is satisfied, which is represented by
$$55 < v 1 pave < 95. \qquad ( 3 )$$

3. The imaging lens according to claim 1,
wherein the first lens group includes, in consecutive order from the position closest to the object side to the image side, the two positive lenses, a positive lens, and a negative lens.

4. The imaging lens according to claim 1,
wherein an aperture stop is disposed between the lens surface of the first lens group closest to the image side and a lens surface of the second lens group closest to the object side.

5. The imaging lens according to claim 1,
wherein the first lens group includes, in order from the object side to the image side, only six lenses consisting of the two positive lenses, a positive lens, a negative lens, a positive lens, and a negative lens as lenses.

6. The imaging lens according to claim 1,
wherein the second lens group includes at least one positive lens and at least one negative lens.

7. The imaging lens according to claim 6,
wherein the second lens group consists of one cemented lens in which a positive lens and a negative lens are cemented.

8. The imaging lens according to claim 1,
wherein a lens component having a positive refractive power is disposed adjacent to the object side of the lens component having the negative refractive power closest to the image side in the third lens group.

9. The imaging lens according to claim 1,
wherein an aperture stop is disposed between the lens surface of the first lens group closest to the image side and a lens surface of the second lens group closest to the object side,
the lens surface of the first lens group closest to the image side and the lens surface of the second lens group closest to the object side have concave shapes, and
in a case where a curvature radius of the lens surface of the first lens group closest to the image side is denoted by RG1r,
a curvature radius of the lens surface of the second lens group closest to the object side is denoted by RG2f, and
a focal length of the imaging lens in the state where the infinite distance object is in focus is denoted by f,
Conditional Expression (4) is satisfied, which is represented by
$$0.7 < ( ( RG 1 r - RG 2 f ) / f < 4. \qquad ( 4 )$$

10. The imaging lens according to claim 1,
wherein, in a case where a back focus of the imaging lens as an air conversion distance in the state where the infinite distance object is in focus is denoted by Bf, and
a focal length of the imaging lens in the state where the infinite distance object is in focus is denoted by f,
Conditional Expression (5) is satisfied, which is represented by
$$0.7 < Bf / ( f \times tan ω m ) < 3. \qquad ( 5 )$$

11. The imaging lens according to claim 1,
wherein, in a case where a focal length of the imaging lens in the state where the infinite distance object is in focus is denoted by f, and
a focal length of the lens component having the negative refractive power closest to the image side in the third lens group is denoted by fLe1,
Conditional Expression (6) is satisfied, which is represented by
$$- 3.2 < f / fLe 1 < - 0.6 . \qquad ( 6 )$$

12. The imaging lens according to claim 1,
wherein, in a case where a lateral magnification of the second lens group in the state where the infinite distance object is in focus is denoted by β2, and
a lateral magnification of the third lens group in the state where the infinite distance object is in focus is denoted by β3,
Conditional Expression (7) is satisfied, which is represented by
$$1.3 < \vert ( 1 - β {2}^{2} ) \times β {3}^{2} \vert < 3.5 . \qquad ( 7 )$$

13. The imaging lens according to claim 1,
wherein, in a case where a sum of DA and a back focus of the imaging lens as an air conversion distance in the state where the infinite distance object is in focus is denoted by TL,
Conditional Expression (8) is satisfied, which is represented by
$$0.1 < DG 1 / TL < 0.3 . \qquad ( 8 )$$

14. The imaging lens according to claim 1,
wherein, in a case where a height of an on-axis marginal ray from the optical axis on the lens surface of the first lens group closest to the image side in the state where the infinite distance object is in focus is denoted by H1r, and
a height of an on-axis marginal ray from the optical axis on the lens surface of the first lens group closest to the object side in the state where the infinite distance object is in focus is denoted by H1f,
Conditional Expression (9) is satisfied, which is represented by
$$0.5 < H 1 r / H 1 f < 0.85 . \qquad ( 9 )$$

15. The imaging lens according to claim 1,
wherein, in a case where a distance on the optical axis from the lens surface of the first lens group closest to the object side to a paraxial entrance pupil position in the state where the infinite distance object is in focus is denoted by Den, and
a focal length of the imaging lens in the state where the infinite distance object is in focus is denoted by f,
Conditional Expression (10) is satisfied, which is represented by
$$0.2 < Den / f < 0.5 . \qquad ( 10 )$$

16. The imaging lens according to claim 1,
wherein, in a case where a focal length of the imaging lens in the state where the infinite distance object is in focus is denoted by f, and
a focal length of the first lens group is denoted by f1,
Conditional Expression (11) is satisfied, which is represented by
$$1. 2 < f / f 1 < 2. \qquad ( 11 )$$

17. The imaging lens according to claim 1,
wherein, in a case where a focal length of the imaging lens in the state where the infinite distance object is in focus is denoted by f, and
a focal length of the second lens group is denoted by f2,
Conditional Expression (12) is satisfied, which is represented by
$$- 3 < f / f 2 < - 1.3 . \qquad ( 12 )$$

18. The imaging lens according to claim 1,
wherein, in a case where a focal length of the imaging lens in the state where the infinite distance object is in focus is denoted by f, and
a focal length of the third lens group is denoted by f3,
Conditional Expression (13) is satisfied, which is represented by
$$0.8 < f / f 3 < 2.5 . \qquad ( 13 )$$

19. The imaging lens according to claim 1,
wherein, in a case where a distance on the optical axis from a lens surface of the second lens group closest to the object side to a lens surface of the second lens group closest to the image side is denoted by DG2, and
a sum of DA and a back focus of the imaging lens as an air conversion distance in the state where the infinite distance object is in focus is denoted by TL,
Conditional Expression (14) is satisfied, which is represented by
$$0.02 < DG 2 / TL < 0.1 . \qquad ( 14 )$$

20. An imaging apparatus comprising:
the imaging lens according to claim 1.
